(19) United States
(12) Patent Application Publication
(10) Pub. No.: US 2023/0127086 A1
(43) Pub. Date: Apr. 27, 2023

(54) BEHAVIOR RECOGNITION DEVICE, BEHAVIOR RECOGNITION METHOD, AND NON-TRANSITORY COMPUTER-READABLE RECORDING MEDIUM

(71) Applicant: Panasonic Intellectual Property Corporation of America, Torrance, CA (US)

(72) Inventors: Nobuhiko WAKAI, Tokyo (JP); Kazuki KOZUKA, Osaka (JP); Shigehiro IIDA, Tokyo (JP); Yohei NAKATA, Osaka (JP); Yumiko SHINOHARA, Tokyo (JP)

(73) Assignee: Panasonic Intellectual Property Corporation of America, Torrance, CA (US)

(21) Appl. No.: 18/089,071

(22) Filed: Dec. 27, 2022

Related U.S. Application Data
(63) Continuation of application No. PCT/JP2021/014244, filed on Apr. 1, 2021.

(30) Foreign Application Priority Data
Jul. 10, 2020 (JP) 2020-119202

(51) Int. Cl. G06V 40/20; G06V 20/70; G06V 10/82

(52) U.S. Cl. CPC G06V 40/20; G06V 10/82; G06V 20/70

(57) ABSTRACT

Provided is a behavior recognition device that selects a candidate behavior as a recognition candidate from among target behaviors based on position information on an image sensor and room layout information, acquires image data detected by the image sensor, determines one or more recognizers corresponding to the candidate behavior, calculates a feature value of the image data using the one or more recognizers, and recognizes the candidate behavior based on the feature value.

### TECHNICAL FIELD

The present disclosure relates to a technique for recognizing a behavior of a user in a building.

### BACKGROUND ART

In recent years, research for recognizing a behavior of a person from a moving image has been advanced. For example, Patent Literature 1 discloses a technique for detecting a human region including a person from a moving image and recognizing a behavior of the person from a combination of a posture of the person appearing in the region and a surrounding object.

For example, Patent Literature 2 discloses a technique for extracting skeleton information based on a human joint from a moving image in time series, extracting a surrounding region of the skeleton information, and recognizing a behavior of a person from the extracted surrounding region.

Unfortunately, the techniques of Patent Literature 1 and Patent Literature 2 do not consider room layout information on a building, and thus are required to be improved to accurately recognize a behavior of a person depending on a space in the building.

### CITATION LIST

### Patent Literatures

Patent Literature 1: JP 2018-206321 A
Patent Literature 2: JP 2019-144830 A

### SUMMARY OF INVENTION

A behavior recognition device according to an aspect of the present disclosure is a behavior recognition device that recognizes a behavior of a person in a building, the behavior recognition device including: a first acquisition unit that acquires target behavior information including one or more target behaviors that are each to be a predetermined recognition target, room layout information on the building, and position information on an image sensor installed in the building; a behavior selection unit that selects a candidate behavior that is a recognition candidate from among the one or more target behaviors included in the target behavior information based on the position information on the image sensor and the room layout information; a second acquisition unit that acquires image data detected by the image sensor; a first behavior recognition unit that determines one or more recognizers corresponding to the candidate behavior and calculates a feature value of the image data using the one or more recognizers; a second behavior recognition unit that recognizes the candidate behavior based on the feature value; and an output unit that outputs a recognition result acquired by the second behavior recognition unit.

The present disclosure enables a behavior of a person depending on a space in a building to be accurately recognized.

### BRIEF DESCRIPTION OF DRAWINGS

FIG. 1 is a block diagram illustrating an example of a configuration of a behavior recognition device according to an embodiment.

FIG. 2 is an explanatory diagram of a CNN constituting a recognizer.

FIG. 3 is a diagram illustrating an example of a configuration of a first behavior recognition unit.

FIG. 4 is a diagram illustrating an example of a configuration of a behavior selection table.

FIG. 5 is a diagram illustrating an example of a configuration of a recognizer selection table.

FIG. 6 is a diagram illustrating an example of a weight table that is referred to when a coupler sets a weight coefficient for a feature value.

FIG. 7 is a flowchart illustrating an example of generation processing of list information in a behavior recognition device according to an embodiment.

FIG. 8 is a flowchart illustrating details of processing in step S106 in FIG. 7.

FIG. 9 is a flowchart illustrating an example of behavior recognition processing in a behavior recognition device.

FIG. 10 is a diagram illustrating a data configuration of a previous knowledge table summarizing information on a recognizer.

FIG. 11 is a table summarizing a processing time per frame when existing recognizers are individually executed.

FIG. 12 is a table summarizing input image data.

FIG. 13 is a table summarizing results of simulation performed to evaluate recognition accuracy of a behavior recognition device.

FIG. 14 is a block diagram illustrating an example of a configuration of a behavior recognition device according to a modification of the present disclosure.

FIG. 15 is a block diagram illustrating an example of a configuration of a behavior recognition device according to a modification (3) of the present disclosure.

FIG. 16 is a diagram illustrating a scene in which an image sensor is installed at an entrance.

FIG. 17 is a diagram illustrating an example of interaction between a user and a display terminal in a scene where an image sensor is installed at an entrance.

FIG. 18 is a diagram illustrating interaction subsequent to FIG. 17.

FIG. 19 is a diagram illustrating an example of a setting screen on which an annotation image is superimposed.

FIG. 20 is a diagram illustrating a scene in which an image sensor is installed in a kitchen.

FIG. 21 is a diagram illustrating an example of interaction between a user and a display terminal in a scene where an image sensor is installed in a kitchen.

FIG. 22 is a diagram illustrating interaction subsequent to FIG. 21.

FIG. 23 is a diagram illustrating an example of a setting screen on which an annotation image is superimposed.

FIG. 24 is a diagram illustrating an example of interaction between a user and a display terminal when an annotation image is corrected after an image sensor is installed.

FIG. 25 is a diagram illustrating an example of a setting screen on which an annotation image is displayed in a superimposed manner.

### DESCRIPTION OF EMBODIMENTS

### Knowledge Leading to the Present Disclosure

A method for estimating a behavior of a person from a moving image or a still image that is sensor data has been conventionally proposed. In such a method, a label is preliminarily assigned to a behavior of a target to be recognized and it is determined which label corresponds to the sensor data. When the sensor data is a moving image or a still image, high recognition accuracy can be achieved by using a deep neural network (DNN) using a convolutional layer and a pooling layer. However, a current method using a DNN recognizes a behavior that does not depend on a space in which a person moves, such as walking, as a recognition target. Thus, to set a behavior depending on a space as a recognition target, the DNN is required to learn from scratch in consideration of information on the space, and thus taking time and cost.

Although in Patent Literature 1 described above, a behavior of a person is recognized in consideration of a combination of a posture of the person and an object around the person, an object irrelevant to the behavior of the person, the object appearing around the person, is not useful information to estimate the behavior of the person. Thus, further improvement is required in Patent Literature 1 to recognize the behavior of the person depending on the space.

Patent Literature 2 described above is based on assumption that a behavior of a recognition target does not depend on a background as is clear from the behavior of the person that is estimated from the surrounding region of the skeleton information. Thus, further improvement is required in Patent Literature 2 to estimate a behavior strongly dependent on a space, such as a cooking behavior performed in a kitchen.

Then, the present inventors have acquired knowledge that a behavior of a person depending on a space in a building can be accurately recognized in consideration of room layout information of the building, and have conceived each aspect of the present disclosure described below.

A behavior recognition device according to an aspect of the present disclosure is a behavior recognition device that recognizes a behavior of a person in a building, the behavior recognition device including: a first acquisition unit that acquires target behavior information including one or more target behaviors that are each to be a predetermined recognition target, room layout information on the building, and position information on an image sensor installed in the building; a behavior selection unit that selects a candidate behavior that is a recognition candidate from among the one or more target behaviors included in the target behavior information based on the position information on the image sensor and the room layout information; a second acquisition unit that acquires image data detected by the image sensor; a first behavior recognition unit that determines one or more recognizers corresponding to the candidate behavior and calculates a feature value of the image data using the one or more recognizers; a second behavior recognition unit that recognizes the candidate behavior based on the feature value; and an output unit that outputs a recognition result acquired by the second behavior recognition unit.

According to the present configuration, a candidate behavior to be a recognition target is selected from among target behaviors based on position information on an image sensor and room layout information on a building, and then a recognition result for the candidate behavior is calculated. Thus, a behavior of a person depending on a space in the building can be accurately recognized.

According to the present configuration, the first behavior recognition unit determines a recognizer corresponding to the candidate behavior to calculate a feature value of image data using the determined recognizer, and the second behavior recognition unit recognizes the candidate behavior from the calculated feature value. This configuration enables an existing recognizer to be used as the recognizer, and thus facilitating construction of the behavior recognition device. The feature value is calculated using one or more recognizers corresponding to the candidate behavior, so that calculate a feature value suitable for recognition of the candidate behavior, and thus enabling recognition accuracy of a target behavior to be enhanced.

The behavior recognition device may be configured such that the first behavior recognition unit determines a plurality of recognizers when the candidate behavior is a predetermined behavior, and the second behavior recognition unit combines feature values calculated by the plurality of recognizers to recognize the candidate behavior based on the combined feature values.

According to the present configuration, the plurality of recognizers are determined when the target behavior is the predetermined behavior. Thus, when the predetermined behavior depends on an object around a person, for example, the feature values can be calculated using the recognizer that calculates a feature value of the person and the recognizer that calculates a feature value of the object, and thus enabling improvement in recognition accuracy of the candidate behavior.

According to the present configuration, the feature values calculated by the respective recognizers are combined to recognize the target behavior based on the combined feature values. This configuration enables the feature values to be combined into one feature value when the plurality of recognizers calculate a plurality of feature values, so that the feature values can be input to the second behavior recognition unit, and thus enabling the behavior recognition device to have a simple configuration.

The behavior recognition device may be configured such that the predetermined behavior is cleaning, brushing teeth, cooking, washing, using a computer, reading, or eating.

The present configuration enables a feature value of a behavior of a person, the behavior depending on an object around the person, such as cleaning or brushing a tooth, to be accurately calculated from image data.

The behavior recognition device may be configured such that each of the recognizers is constituted of a convolution neural network (hereinafter, referred to as CNN), and the second behavior recognition unit recognizes the candidate behavior using a classifier using any one of logistics regression, a support vector machine, a decision tree, random forest, a k-nearest neighbor algorithm, Gaussian naive Bayes, a perceptron, and a stochastic descent method.

According to the present configuration, each of the recognizers is constituted of the CNN, and the second behavior recognition unit is constituted of the classifier using logistic regression or the like, so that the second behavior recognizer can be constituted of the classifier lower in processing cost than the first behavior recognition unit.

The behavior recognition device may be configured such that the second behavior recognition unit recognizes the candidate behavior using a classifier that is machine-learned with the feature value as an explanatory variable and the target behavior as an objective variable.

The present configuration enables the second behavior recognition unit to be configured using a classifier generated by machine learning in which a feature value calculated by each recognizer is an explanatory variable and a candidate behavior corresponding to the feature value is an objective variable. For example, when a classifier having a smaller processing load than the CNN such as the logistic regression described above is used as the classifier, the classifier can be learned in a short time. Then, the first behavior recognition unit including an existing recognizer constituted of a CNN enables the behavior recognition device to be configured by causing only the second behavior recognition unit to perform machine learning without causing the first behavior recognition unit to perform machine learning.

The behavior recognition device may be configured such that the second behavior recognition unit weights each feature value using a weight coefficient determined in advance in accordance with the candidate behavior, and recognizes the candidate behavior based on each feature value weighted.

The present configuration enables the candidate behavior to be accurately recognized because each feature value is weighted in accordance with the target behavior, and the candidate behavior is recognized based on each feature value weighted.

The behavior recognition device may be configured as follows: one or more objects installed in the building are extracted from the room layout information; the one or more objects are classified into any one of a first object that is movable, a second object that is a plumbing facility, and a third object that is a structure of the building; a room feature value in which classification information indicating a classification result is associated with an installation position is extracted for each of the one or more objects; a behavior selection table is generated based on the room feature value; the behavior selection table shows one or more spaces of the building that are associated with the corresponding one or more target behaviors; and the first acquisition unit acquires the behavior selection table as the target behavior information.

The present configuration causes the room layout feature value in which the classification information is associated with the installation position to be extracted for each object installed in the building based on the room layout information. This configuration enables grasping what kind of object is installed in each of the spaces in the building, so that information useful for creating the behavior selection table can be extracted. Then, the behavior selection table in which each of the spaces of the building is associated with the corresponding one of the target behaviors is generated based on the room layout feature value, and the behavior selection table is acquired as the target behavior information. Thus, a relationship between each of the spaces and the target behavior can be quickly grasped, and the candidate behavior can be easily selected.

The behavior recognition device may further include an installation support unit that is communicably connected to a display terminal, and that is configured to acquire a name of a space of the building in which the image sensor is installed using the display terminal, and output installation guidance to the display terminal, the installation guidance being for installing the image sensor with a field of view including a specific device or a specific facility related to the space.

The present configuration enables a user to appropriately install the image sensor because the installation guidance for installing the image sensor with the field of view including the specific device or the specific facility related to the space is output to the display terminal. The name of the space of the building is further acquired using the display terminal, so that the image sensor can be associated with the space in which the image sensor is installed. As a result, the candidate behavior can be easily selected with reference to the installation position of the image sensor and the behavior selection table.

The behavior recognition device may be configured such that the installation support unit acquires image data captured by the image sensor, detects the specific device or the specific facility included in the image data, and superimposes and displays an annotation image indicating a detection result of the specific device or the specific facility on an image indicated by the image data.

The present configuration causes the annotation image that is the detection result of the specific device or the specific facility detected from the image data to be displayed in a superimposed manner on the image indicated by the image data. This configuration enables easy checking whether the specific device or the specific facility is correctly detected from the image data.

The behavior recognition device may be configured such that the installation support unit acquires a correction instruction of the annotation image using the display terminal to store annotation information indicated by the annotation image corrected in a memory.

The present configuration enables the annotation information to be corrected to accurately indicate a position of the specific device or the specific facility when the recognizer cannot correctly detect the specific device or the specific facility, for example, because the correction instruction of the annotation information is acquired using the display terminal. This configuration further enables the recognizer to grasp the position of the specific device or the specific facility on the image, the position being important to recognize the target behavior.

The present disclosure may also be achieved as a method for recognizing a behavior, in which a computer executes each of characteristic configurations included in the behavior recognition device described above and a behavior recognition program for causing a computer to execute each of the characteristic configurations. It is needless to say that such a behavior recognition program can be distributed using a computer-readable non-transitory recording medium such as a CD-ROM, or via a communication network such as the Internet.

Each of embodiments described below illustrates a specific example of the present disclosure. Numerical values, shapes, components, steps, order of steps, and the like shown in the embodiments below are merely examples, and are not intended to limit the present disclosure. The components in the embodiments below includes a component that is not described in independent claims indicating the highest concept, and then the component is described as an optional component. In all the embodiments, respective contents can be combined.

### Embodiments

A method for recognizing a behavior of a person using a computer is classified into three types by a relationship between the person and a space where the person is present. A first type is a method for recognizing a behavior irrelevant to the space in which the person is present. For example, a behavior such as walking or standing is expressed only by movement of a person of interest, and is irrelevant to a space where the person is present. A second type is a method for recognizing a behavior involved with an object existing in a space where a person is present or an object located near the person. For example, a behavior of riding on a bicycle can be recognized by combining posture detection of a person and object detection. When a behavior of a person involved in an object is recognized outdoors or the like, it is difficult to grasp a structure of a building, a state of a road, or the like in advance. Thus, this kind of behavior can be recognized by performing recognition processing using a person and an object around the person. A third type is a method for recognizing a behavior by grasping both a person and a space where the person is present. For example, a behavior of starting cooking in a kitchen can be recognized by a person existing in the kitchen and facing a microwave oven.

As described above, conventional recognition methods of the first type and the second type cannot recognize a behavior such as “starting cooking” that is difficult to be recognized when information on a space where a person is present is not used. The present embodiment discloses a method for recognizing a behavior of a person using room layout information on a person and a space where the person is present. Hereinafter, the present embodiment will be described with reference to the drawings. The behavior of a person to be a recognition target in the present embodiment includes not only a behavior accompanied by movement such as starting cooking or cleaning, but also a behavior not accompanied by movement such as watching a television while lying down.

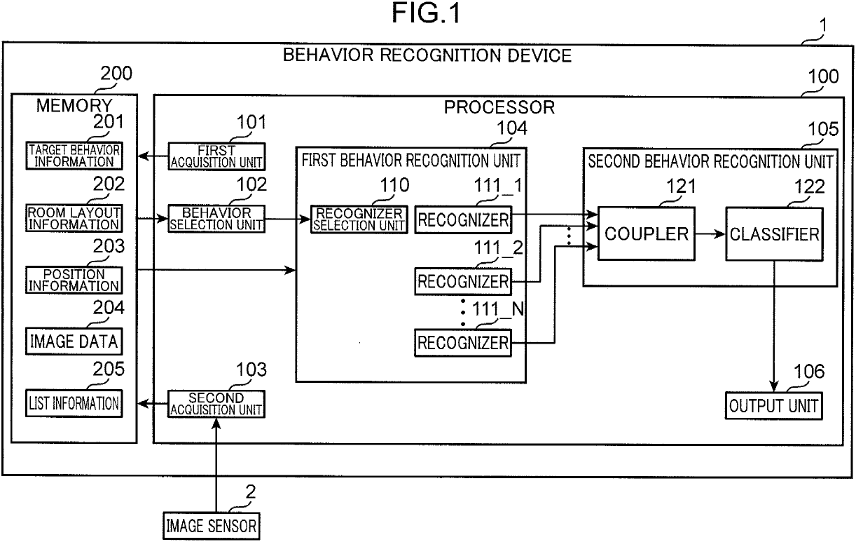

FIG. 1 is a block diagram illustrating an example of a configuration of a behavior recognition device 1 according to an embodiment. The behavior recognition device 1 recognizes a behavior of a user in a home of the user (an example of a building).

For example, the behavior recognition device 1 is constituted of a computer including a processor, a memory, an interface circuit, and the like. The behavior recognition device 1 does not need to be fabricated by a single computer, and may be fabricated by a distributed processing system (not illustrated) including a terminal device and a server. For example, the behavior recognition device 1 may be configured such that a memory for storing image data 204 is provided in a terminal device in the home, and some or all blocks constituting a processor 100 are provided in a server. This mode will be described in a modification to be described later.

The behavior recognition device 1 includes the processor 100 and a memory 200. The memory 200 is constituted of a nonvolatile storage device such as an SSD or an HHD, and stores target behavior information 201, room layout information 202, position information 203, the image data 204, and list information 205. The memory 200 may store the image data 204 for a predetermined time (e.g., one minute) going back from the present to the past among the image data 204 acquired by a second acquisition unit 103 from an image sensor 2 at a predetermined frame rate.

The image sensor 2 is constituted of a camera installed in the home, for example. The image sensor 2 captures an image of a space in the home at a predetermined frame rate to acquire the image data 204, and inputs the image data 204 to the second acquisition unit 103. A plurality of image sensors 2 may be provided. The image data 204 may be color image data or monochrome image data, for example.

The processor 100 is constituted of an electric circuit such as a CPU. The processor 100 includes a first acquisition unit 101, a behavior selection unit 102, a second acquisition unit 103, a first behavior recognition unit 104, a second behavior recognition unit 105, and an output unit 106. Each of these blocks is implemented when the processor 100 executes a behavior recognition program. However, this is an example, and each of these blocks may be implemented with a dedicated hardware circuit such as an application specific integrated circuit (ASIC).

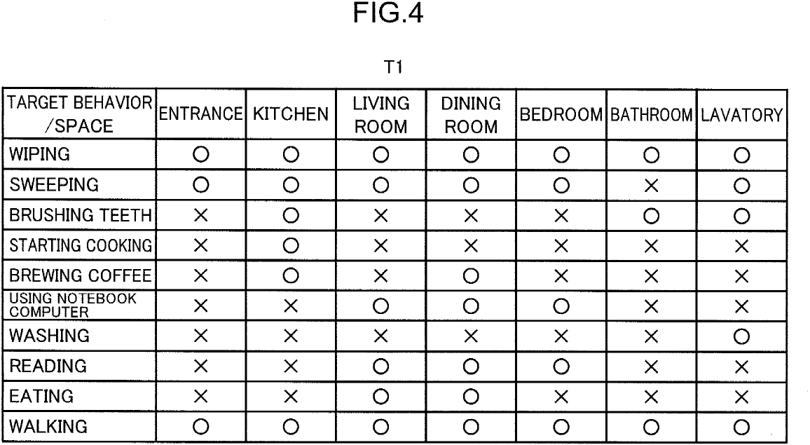

The first acquisition unit 101 acquires target behavior information indicating a target behavior to be a predetermined recognition target, and stores the target behavior information 201 in the memory 200. For example, the first acquisition unit 101 may acquire the target behavior information 201 input through registration work using an input device (not illustrated). For example, the input device is constituted of a keyboard, a mouse, and the like. However, this is an example, and the target behavior information 201 may be stored in the memory 200 in advance. The target behavior is each of various behaviors such as wiping and sweeping registered in a behavior selection table T1 illustrated in FIG. 4, for example. The target behavior information 201 may be stored in the memory 200 in advance. The behavior selection table T1 is an example of the target behavior information 201.

The first acquisition unit 101 also acquires the room layout information 202 on the home, and stores the room layout information 202 in the memory 200. The room layout information 202 is two-dimensional or three-dimensional information expressing components of rooms such as a living room, a dining room, and a kitchen, and a shape and a positional relationship of each room. For example, the room layout information 202 includes two-dimensional drawing data describing a room layout, three-dimensional design data (CAD data) used for home design, three-dimensional point cloud information (point cloud) on the home measured by a three-dimensional laser scanner, trajectory information of a device moving in the home such as a cleaning robot, in-home video data captured by a calibrated camera, or information acquired from a device having information on an installed room.

The first acquisition unit 101 further acquires the position information 203 on the image sensor 2 installed in the home, and stores the position information 203 in the memory 200. For example, the position information 203 includes coordinate data represented by a coordinate system of a coordinate space of two or three axes included in the room layout information 202. The first acquisition unit 101 acquires the position information 203 input through registration work using the input device (not illustrated), for example.

The behavior selection unit 102 selects a candidate behavior as a recognition candidate from among target behaviors based on the position information 203 on the image sensor 2 and the room layout information 202. For example, the behavior selection unit 102 specifies a space in the home in which the image sensor 2 is installed from the position information 203 and the room layout information 202, and selects a predetermined behavior that is estimated that the user acts in the specified space. Specifically, the behavior selection unit 102 may determine a behavior corresponding to the specified space by referring to the behavior selection table T1 illustrated in FIG. 4. The space is a space constituting the home such as a room, an entrance, or a kitchen, for example.

The second acquisition unit 103 acquires the image data 204 captured by the image sensor 2 at a predetermined frame rate, and stores the image data 204 in the memory 200.

The first behavior recognition unit 104 determines one or more recognizers suitable for the candidate behavior selected by the behavior selection unit 102, and calculates a feature value of the image data 204 using the determined one or more recognizers. The first behavior recognition unit 104 includes a recognizer selection unit 110, and N (N is an integer of one or more) recognizers 111_1, 111_2, ... 111_N. Hereinafter, the recognizers 111_1, 111_2, ... 111_N are collectively referred to as a recognizer 111 as needed.

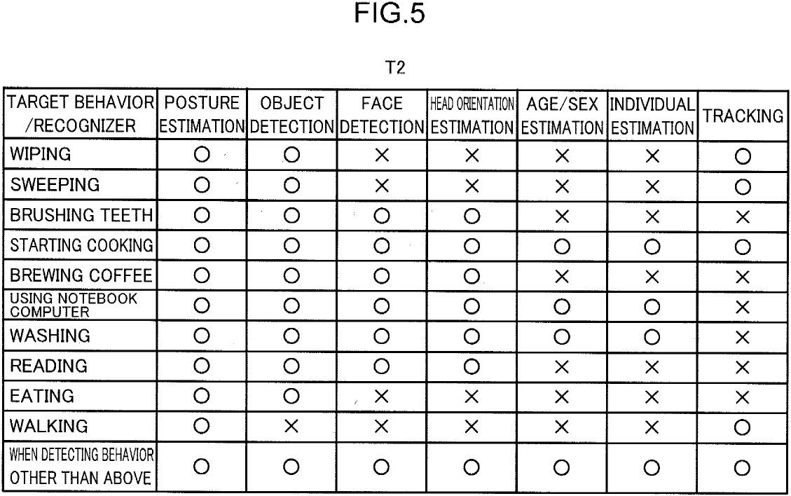

The recognizer selection unit 110 selects the recognizer 111 to be used for recognition of the candidate behavior selected by the behavior selection unit 102. For example, the recognizer selection unit 110 may select the recognizer 111 suitable for the candidate behavior by referring to a recognizer selection table T2 illustrated in FIG. 5 at the time of creating the list information 205 to be described later, and select the recognizer 111 for the candidate behavior by referring to the list information 205 to be described later at the time of performing the recognition processing.

The recognizer 111 is a recognition device constituted of a CNN, for example. As illustrated in FIG. 5, the first behavior recognition unit 104 of the present embodiment includes recognizers 111 that individually recognize posture estimation, object detection, face detection, head orientation estimation, age-sex estimation, individual estimation, and tracking. These recognizers 111 are obtained by diverting or partially modifying existing recognizers with respective source codes disclosed.

The feature value varies depending on the recognizer 111. The feature value calculated by the recognizer 111 for the posture estimation includes two-dimensional coordinate data representing each of a plurality of feature points (e.g., 17 points such as a right shoulder and a right elbow) constituting skeleton information, for example.

The feature value calculated by the recognizer 111 for the object detection includes coordinate data on a circumscribed rectangle surrounding an object and a label of the recognized object, for example. The object detected in the object detection is a given, and 80 types of in-home objects (microwave oven, refrigerator, and the like) are detected, for example. The feature value calculated by the recognizer 111 for the face detection includes image data on a face area surrounding a face with a circumscribed rectangle, for example. Here, the feature value calculated by each of the recognizers 111 is not data that cannot be understood by a person (e.g., tensor) like output from an intermediate layer of a DNN.

The first behavior recognition unit 104 includes a recognizer 111 that depends on another recognizer 111 in accordance with the candidate behavior. The recognizer 111 dependent on the other recognizer 111 receives a feature value calculated by the other recognizer 111 to calculate a feature value using the feature value. For example, the recognizer 111 for the head orientation estimation calculates a feature value indicating a head orientation using the feature value (image data on the face area) calculated by the recognizer 111 for the face detection.

The second behavior recognition unit 105 recognizes each candidate behavior selected by the behavior selection unit 102 based on the feature value calculated by the corresponding one of the recognizers 111. The second behavior recognition unit 105 includes a coupler 121 and a classifier 122. The coupler 121 combines the feature values calculated by respective couplers 121, and inputs the combined feature values to the classifier 122. Here, the coupler 121 may weight each feature value using a weight coefficient determined in advance in accordance with the candidate behavior, and couple the weighted feature values to input the coupled feature values to the classifier 122.

The classifier 122 recognizes the candidate behavior by calculating likelihood for the candidate behavior based on the feature value received from the coupler 121. The classifier 122 includes a classifier that performs class classification. Examples of the classifier 122 include a classifier using any one of logistics regression, a support vector machine, a decision tree, a random forest, a k-nearest neighbor algorithm, Gaussian naive Bayes, a perceptron, and a stochastic descent method. When there are a plurality of candidate behaviors, the classifier 122 calculates likelihood for each of the candidate behaviors.

The classifier 122 is machine-learned with a feature value output from the recognizer 111 as an explanatory variable and a target behavior as an objective variable. This machine learning is individually performed for each target behavior. For example, when the target behavior is “start cooking”, the machine learning is performed under conditions where a combined result of feature values output from the respective recognizers 111 used for the target behavior is used as an explanatory variable, and the “start cooking” is used as an objective variable.

The output unit 106 outputs a recognition result of the second behavior recognition unit 105. Specifically, the output unit 106 outputs a recognition result for a behavior of a person based on likelihood calculated by the classifier 122. For example, when there are a plurality of candidate behaviors, the classifier 122 may output a label having the maximum likelihood as a recognition result.

The recognition result is output to an external device (not illustrated) via a communication circuit, for example. The external device may be constituted of a home appliance that is installed in a home and performs control based on a recognition result, for example. The home appliance may be a display device that is installed in the home and displays a recognition result, for example.

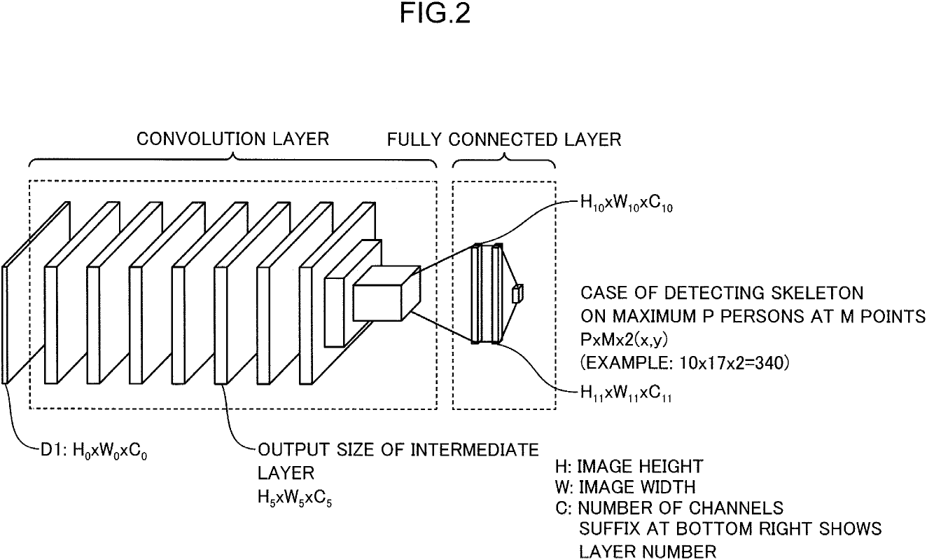

FIG. 2 is an explanatory diagram of a CNN constituting the recognizer 111. The CNN includes a convolutional layer and a fully connected layer. In this example, the CNN includes nine convolutional layers and two fully connected layers. FIG. 2 shows suffixes of various symbols indicating layer numbers in which input image data D1 includes an input layer indicated as a zero-th layer, convolutional layers indicated as first to ninth layers, fully connected layers indicated tenth and eleventh layers, and an output layer indicated as a twelfth layer. The input image data D1 is represented by H0 × W0 × C0. Here, H represents a height of data in each layer, W represents a width of data in each layer, and C represents the number of channels in each layer. When the input image data D1 is color image data, C0 is 3. In the convolutional layer, a feature value of data of each layer is calculated by a convolution operation. For example, the fifth layer outputs data with a size or “H5 × W5 × C5” that is represented by “64 × 64 × 256 = 1048576”.

In the fully connected layer, data output from the convolutional layer is collected to generate output data. For example, a CNN for the posture estimation of detecting skeleton information on maximum P persons at M points causes the fully connected layer to output “P × M × 2 (x, y)” pieces of data as output data.

The CNN has very high recognition accuracy for image data. However, the CNN includes many layers such as a convolutional layer and a fully connected layer, so that a processing load is high and learning takes a lot of time. In contrast, the classifier 122 is a classifier such as a support vector machine having a significantly lower processing load than the CNN. Thus, the present embodiment causes an existing recognizer to be used as the recognizer 111 constituted of a CNN, and the classifier 122 with a low processing load to learn a target behavior. This configuration shortens learning time, and enables the behavior recognition device 1 to be easily constructed.

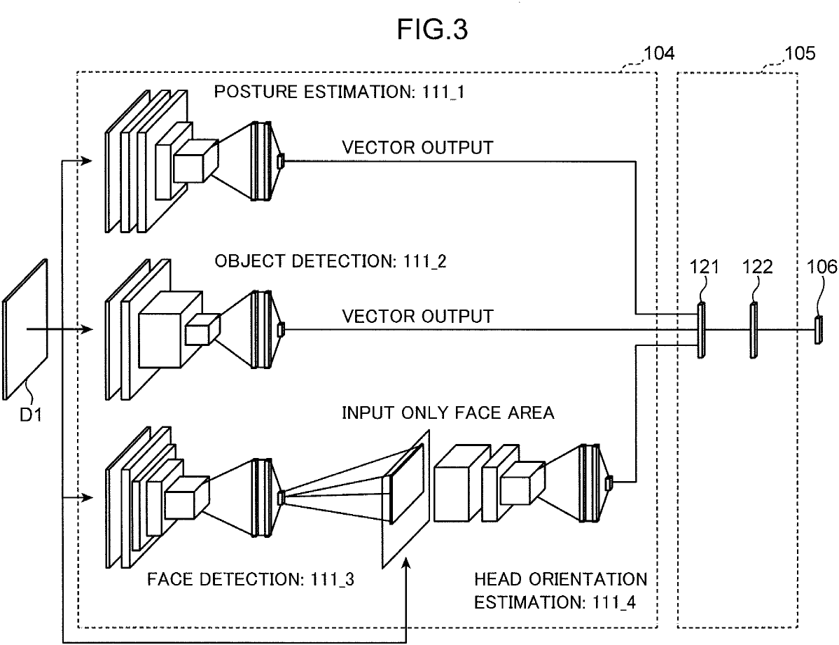

FIG. 3 is a diagram illustrating an example of a configuration of the first behavior recognition unit 104. The first behavior recognition unit 104 of the example includes the recognizer 111_1 that performs the posture estimation, the recognizer 111_2 that performs the object detection, the recognizer 111_3 that performs the face detection, and the recognizer 111_4 that performs the head orientation estimation. The recognizers 111_1 to 111_3 each receive the input image data D1. The input image data D1 is in-home image data captured by the image sensor 2.

Hereinafter, a target behavior of “starting cooking” will be described as an example. For example, the input image data D1 includes a scene in which a person stands facing a refrigerator in a kitchen. When receiving the input image data D1 indicating that a person stands, the recognizer 111_1 outputs coordinate data constituting skeleton information on the standing posture as a feature value. The recognizer 111_2 detects a given object from the input image data D1, and outputs coordinate data on vertexes of a circumscribed rectangle surrounding the detected object and a label of the detected object, as feature values. Here, the refrigerator is detected as an object.

The recognizer 111_3 detects a face of a person from the input image data D1, and outputs image data on a face area surrounding the detected face with a circumscribed rectangle, as a feature value. The recognizer 111_4 estimates the head orientation of the person from the image data on the face area output from the recognizer 111_3. The head orientation is represented by a direction vector starting from the center of gravity of the face area, for example.

When the center of gravity of a circumscribed rectangle surrounding the refrigerator is in a direction of the direction vector, for example, the second behavior recognition unit 105 determines that a person faces the refrigerator. For example, the second behavior recognition unit 105 rotates the direction vector within a range of a plus or minus threshold angle (e.g., plus or minus 30 degrees) from a start point on an image, and determines that the person faces the refrigerator when an extension line of the direction vector passes through the center of gravity of the refrigerator.

Combining these information pieces on a posture of a person, an object position, and a head orientation of the person, enables the second behavior recognition unit 105 to determine the behavior of “starting cooking”. The recognizer 111_4 may detect a direction of a line of sight, a nose orientation, and a normal direction of a torso instead of the head orientation.

FIG. 4 is a diagram illustrating an example of a configuration of the behavior selection table T1. The behavior selection table T1 stores a plurality of spaces in association with target behaviors to be recognition targets for the respective spaces. As the target behaviors, wiping, sweeping, brushing teeth, starting cooking, brewing coffee, using a notebook computer (notebook PC), washing, reading, eating, and walking are adopted. As the space, an entrance, a kitchen, a living room, a dining room, a bedroom, a bathroom, and a lavatory are adopted. However, these are examples, and other spaces and target behaviors may be adopted. For example, a target behavior such as watching a television while lying down on a sofa may be assigned to the living room.

The behavior selection table T1 shows a mark “◯” indicating that a target behavior corresponding to a space is to be a recognition target. A mark “×” indicates that a target behavior corresponding to a space is not to be a recognition target.

For example, the first line illustrates the wiping that is to be a recognition target in the entrance, the kitchen, the living room, the dining room, the bathroom, and the lavatory.

The wiping is likely to be performed in all the spaces, and thus is to be a recognition target in all the spaces. The sweeping is less likely to be performed in the bathroom, and thus is to be a recognition target in the spaces other than the bathroom. The brushing teeth is a behavior performed in a watery space, and thus is to be a recognition target in the kitchen, the bathroom, and the lavatory.

The starting cooking is not performed outside the kitchen, and thus only the kitchen is set as a target space. The brewing coffee is to be a recognition target in the kitchen and the dining room because a coffee maker may be placed in not only the kitchen but also the dining room.

The using a notebook PC is to be a recognition target in the dining room, the living room, and the bedroom because the notebook PC may be used in these spaces.

The washing is to be a recognition target in the lavatory on the assumption that a washing machine is installed in the lavatory. The reading is likely to be performed in a space where a person sits, and thus is to be a recognition target in the living room, the dining room, and the bedroom. The eating may be performed in not only the dining room but also the living room, and thus is to be a recognition target in the living room and the dining room. The walking is performed in all the spaces, and thus is to be a recognition target in all the spaces.

The behavior selection unit 102 can select the target behaviors corresponding to the corresponding spaces by referring to the behavior selection table T1 described above, so that an appropriate target behavior can be selected for each of the spaces.

FIG. 5 is a diagram illustrating an example of a configuration of the recognizer selection table T2. The recognizer selection table T2 stores a plurality of target behaviors in association with the recognizers 111 used to recognize the respective target behaviors. The recognizer selection table T2 shows a mark “◯” mark indicating the recognizer 111 used for the corresponding target behavior, and a mark “×” mark indicating the recognizer not used for the corresponding target behavior. The target behaviors are the same as the target behaviors illustrated in FIG. 4. The posture estimation, the object detection, the face detection, the head orientation estimation, the age-sex estimation, the individual estimation, and the tracking are individually performed by the corresponding recognizers 111.

For example, the wiping does not require identifying an individual, so that the recognizers 111 for the face detection, the head orientation estimation, the age-sex determination, and the individual estimation are not used, and then the recognizers 111 for the posture estimation, the object detection, and the tracking are used.

The sweeping uses the recognizers 111 for the posture estimation, the object detection, and the tracking for the same reason as the wiping. Individual identification and movement are not important for the brushing teeth, so that the recognizers 111 other than those for the age-sex estimation, the individual estimation, and the tracking are used.

All the recognizers 111 are used for the starting cooking. For example, it is assumed that a mother often performs cooking, so that the recognizers 111 for the age-sex estimation and the individual estimation are used for the starting cooking to estimate whether the mother is at the starting cooking.

The recognizers 111 other than those for the age-sex estimation, the individual estimation, and the tracking are used for the brewing coffee because it is assumed that a father or a child also brews coffee unlike the starting cooking, and movement is not important.

The recognizers 111 other than that for the tracking are used for the using a notebook PC because a person rarely moves while using the notebook PC. The recognizers 111 other than that for the tracking are used for the washing because a place where a washing machine is installed is fixed. The recognizers 111 other than those for the age-sex estimation, the individual estimation, and the tracking are used for the reading because individual identification is unnecessary and there is no movement.

The recognizers 111 for the posture estimation and the object detection are used for the eating because anyone will eat, the head orientation is not important, and no movement is assumed. The recognizers 111 for the posture estimation and the tracking are used for the walking because no object is involved, and the head orientation and the individual identification are not important. When an unknown behavior other than the above is detected, all the recognizers 111 are used.

Next, effectiveness of the recognizers 111 used to recognize the corresponding target behaviors will be described.

The posture estimation can detect postures corresponding to the corresponding target behaviors, and thus is effective in recognizing all the target behaviors. The head orientation detection requires face detection. That is, the head orientation detection depends on the face detection.

For the wiping, the object detection is effective in detecting a cleaning tool such as a cleaner, and the tracking is effective because cleaning is performed while a person moves through a plurality of places.

For the sweeping, the object detection and the tracking are effective as with the wiping.

For the brushing teeth, the object detection is effective in detecting a toothbrush and a mirror, and the head orientation estimation is effective because a head tends to face toward the mirror.

For the starting cooking, the object detection is effective in detecting cooking utensils and ingredients, and the head orientation estimation is effective because a head tends to face the kitchen or a sink. Additionally, for the starting cooking, the age-sex estimation and the individual estimation are effective in identifying an individual having a high cooking frequency such as a mother cooking well, and the tracking is effective because a person may move from the sink to a stove in the kitchen.

For the brewing coffee, the object detection is effective in detecting a coffee maker and a coffee cup, and the head orientation estimation is effective in detecting whether a head faces toward the coffee maker.

For the using a notebook PC, the object detection is effective in detecting the notebook PC, the head orientation estimation is effective in detecting whether a head faces the notebook PC, and the age-sex estimation and the individual estimation are effective because the notebook PC may be used at work.

For the washing, the object detection is effective in detecting a washing machine, the head orientation estimation is effective in detecting whether a head faces toward the washing machine, and the age-sex estimation and the individual estimation are effective in identifying an individual such as a mother performing the washing well.

For the reading, the object detection is effective in detecting a book, and the head orientation estimation is effective in detecting whether a head faces the book.

For the eating, the object estimation is effective in detecting a dish.

For the walking, the tracking is effective in capturing continuous movement.

For a behavior other than these target behaviors, what is valid or not valid is unclear, and thus all the recognizers 111 are selected.

The target behavior to be a recognition target by the behavior recognition device 1 is associated with a space. For example, the “starting cooking” is strongly related to a space called a kitchen, and information on this space is useful for behavior recognition. That is, when a specific object, a head orientation, or the like is weighed for a target behavior, detection accuracy of the target behavior is further improved. Thus, the coupler 121 of the present embodiment sets a weight coefficient corresponding to the target behavior as a feature value.

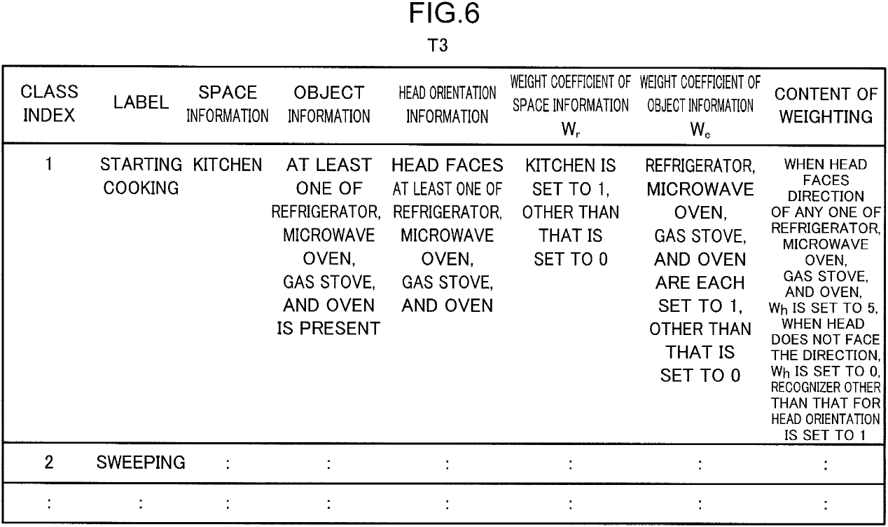

FIG. 6 is a diagram illustrating an example of a weight table T3 that is referred to when the coupler 121 sets a weight coefficient for a feature value. The weight table T3 stores a plurality of target behaviors in association with a class index, a label, space information, object information, head orientation information, a weight coefficient Wr of the space information, a weight coefficient We of the object information, and a content of weighting for each target behavior. Here, the wiping is illustrated as a target behavior in addition to the “starting cooking” illustrated in FIG. 4. Although not illustrated here, a record related to each target behavior illustrated in FIG. 4 is also actually registered in the weight table T3.

The class index is uniquely assigned to each target behavior. Here, the class index is assigned by a serial number. The label is of a target behavior output by the output unit 106. Here, the “starting cooking” and the “wiping” are each exemplified as the label. Although not illustrated here, the label of each target behavior illustrated in FIG. 4 is registered in the weight table T3. The space information is on a space in which the target behavior is performed. Here, the space for the target behavior defined in the behavior selection table T1 is registered, such as the kitchen for the “starting cooking”.

The object information indicates an object related to the corresponding target behavior. For example, the object information corresponding to the “starting cooking” corresponds to at least one of a refrigerator, a microwave oven, a gas stove, and an oven. The head orientation information indicates a relationship between the object described in the object information and a head orientation. For example, the head orientation information on the “starting cooking” is that a head faces at least one of the refrigerator, the microwave oven, the gas stove, and the oven. Whether the head faces each of the objects is determined based on a relationship between the direction vector described above and the center of gravity of each of the objects.

The weight coefficient Wr of the space information is for the space in which the target behavior is performed. Here, the behavior selection table T1 shows a weight coefficient set to “1” for the space with the mark “◯”, and a weight coefficient set to “0” for the space with the mark “×”. For example, the “starting cooking” has the weight coefficient Wr set to “1” for the kitchen because the kitchen has the mark “◯” in the behavior selection table T1, and has the weight coefficient Wr set to “0” for the other spaces.

The weight coefficient We of the object information is for the detected object. The weight coefficient We is set to “1” when the corresponding object is detected, and is otherwise set to “0”. When a plurality of feature values are extracted for one object, the plurality of feature values are each set to 1 or 0. The content of weighting indicates the content of the weight coefficient set in accordance with a relationship between the detected object and the head orientation.

Hereinafter, weighting performed by the coupler 121 will be described using feature values output from the three recognizers 111 of the posture estimation, the object detection, and the head orientation estimation illustrated in FIG. 5, as an example. Here, the coupler 121 finally outputs a vector indicated as Vo. Each recognizer 111 also outputs a vector as a feature value. The output vector Vo is not limited to a one-dimensional vector, and may be a multidimensional tensor. When weighting is not performed, the output vector Vo is expressed by Expression (1).

$${V}_{o} = \left〈{V}_{p} , {V}_{o b ,} {V}_{h}\right〉$$

The recognizer 111 for the posture estimation, the recognizer 111 for the object detection, and the recognizer 111 for the head orientation estimation output feature values that are indicated as Vp, Vob, and Vh, respectively. The output vector Vo without weighting may be obtained by coupling the feature values Vp, Vob, and Vh. The output vector Vo has the number of elements that is the sum of the number of elements of the feature values Vp, Vob, and Vh. The symbol “< >” indicates that the vectors in “< >” are coupled with respective their own directions even after being coupled.

In contrast, when being weighted, the output vector Vo is expressed by Expression (2). When being weighted, an output vector Vo′ is generated by coupling vectors of respective recognizers 111 as with when being not weighted. Then, a feature value of each of the recognizers 111 is weighted. Thus, the number of elements of the output vector Vo′ is the same as that without weighting.

$${{V}^{′}}_{o} = {W}_{r} ⊙ \left〈{W}_{p} ⊙ {V}_{p} , {W}_{o b} ⊙ \left({W}_{e} ⊗ {V}_{o b}\right) , {W}_{h} ⊙ {V}_{h}\right〉$$

Expression (2) includes a symbol of a circle with “·” therein indicating a broadcast operation, and a symbol of a circle with “x” therein indicating a Hadamard product.

The room, the posture estimation, the object detection, and the head orientation estimation have weight coefficients that are indicated as Wr, Wp, Wob, and Wh, respectively. The weight coefficient Wp is subjected to the broadcast operation on the feature value Vp, the weight coefficient Wob is subjected to the broadcast operation on the Hadamard product of the weight coefficient We and the feature value Vob, and the weight coefficient Wh is subjected to the broadcast operation on the feature value Vh. The broadcast operation is of multiplying a weight coefficient (scalar value) by each element of a vector. The weight coefficient We is of an object, and has as many elements as the feature value Vob.

For example, it is assumed that the target behavior is the “starting cooking”, the input image data D1 is captured in the kitchen, the feature value Vob includes a label of the refrigerator, and the feature value Vh includes a direction vector facing the refrigerator. In this case, the coupler 121 refers to the weight table T3 and sets the weight coefficient Wr to “1”, the weight coefficient We to “1”, the weight coefficient Wh to “5”, and the weight coefficient Wob to “1”.

Here, the weighting by Expression (2) has been described in an example with one target behavior for simplicity of description. For two or more target behaviors, the coupler 121 may weight each target behavior according to Expression (2) and input the weighted feature value to the classifier 122. The classifier 122 may individually calculate likelihood for each target behavior. For example, when two behaviors of the “starting cooking” and the “wiping” are recognized, the coupler 121 may set each weight coefficient of Expression (2) to a value corresponding to the “starting cooking”, and then set the weight coefficient of Expression (2) to a value corresponding to the “wiping”.

As another method for two or more target behaviors, examples of an applicable method include a method for integrating weight coefficients by taking an arithmetic mean, an arithmetic sum, or a logical sum of weight coefficients for each of the “starting cooking” and the “sweeping”.

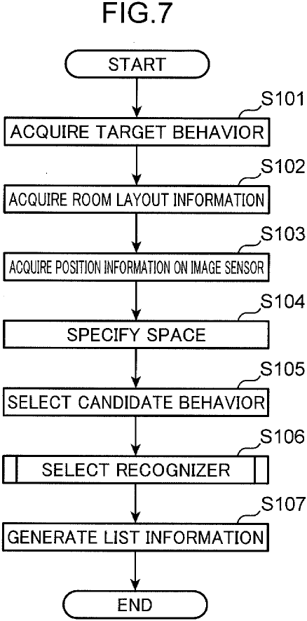

FIG. 7 is a flowchart illustrating an example of generation processing of the list information 205 in the behavior recognition device 1 according to the embodiment. Details of the list information 205 will be described later. The flowchart of FIG. 7 is executed when the behavior recognition device 1 is installed in the home, for example. The flowchart of FIG. 7 may be also executed when the room layout information 202 or the position information 203 is changed, for example.

First, the first acquisition unit 101 acquires the behavior selection table T1 (target behavior information 201) and stores the acquired table in the memory 200 (step S101). Next, the first acquisition unit 101 acquires the room layout information 202 and stores the room layout information in the memory 200 (step S102).

Subsequently, the second acquisition unit 103 acquires the position information 203 on the image sensor 2, and stores the position information 203 in the memory 200 (step S103). When there are a plurality of image sensors 2, the second acquisition unit 103 may acquire the position information 203 on each image sensor 2.

Subsequently, the behavior selection unit 102 specifies a space in which the image sensor 2 is installed using the position information 203 and the room layout information 202 (step S104). For example, the behavior selection unit 102 may specify a space by checking a space in which coordinate data indicated by the position information 203 is located among a plurality of spaces included in the room layout information 202. When the position information 203 for the plurality of image sensors 2 is acquired, the behavior selection unit 102 may specify a space corresponding to each piece of position information 203.

Subsequently, the behavior selection unit 102 refers to the behavior selection table T1 and selects a candidate behavior that is the target behavior corresponding to the specified space (step S105). Here, when a plurality of spaces are specified, one or more candidate behaviors corresponding to the respective spaces are selected. When a plurality of candidate behaviors are selected, the recognizers 111 corresponding to the respective candidate behaviors are selected.

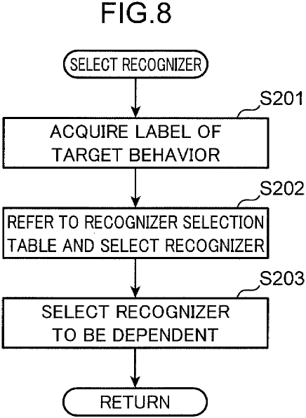

Subsequently, the recognizer selection unit 110 selects the recognizer 111 corresponding to the selected candidate behavior (step S106). Details of this processing will be described later with reference to FIG. 8.

Subsequently, the recognizer selection unit 110 generates the list information 205 in which an identifier of each image sensor 2, the candidate behavior recognized from the image data 204 captured by each image sensor 2, and the recognizer 111 used for recognizing the candidate behavior are associated with each other, and stores the list information 205 in the memory 200 (step S107). As described above, the list information 205 is generated.

FIG. 8 is a flowchart illustrating details of the processing in step S106 in FIG. 7. First, the recognizer selection unit 110 acquires a label of the target behavior acquired in step S101 (step S201). Next, the recognizer selection unit 110 refers to the recognizer selection table T2 and selects the recognizer 111 to be used for recognition of the target behavior (step S202). Here, for a plurality of target behaviors, the recognizer 111 to be used for recognition is selected for each target behavior. Subsequently, the recognizer selection unit 110 selects the recognizer 111 to be dependent (step S203). Here, it is determined which recognizer 111 depends on which recognizer 111 by referring to an item of a dependency relationship of recognizers in a previous knowledge table T4 to be described later.

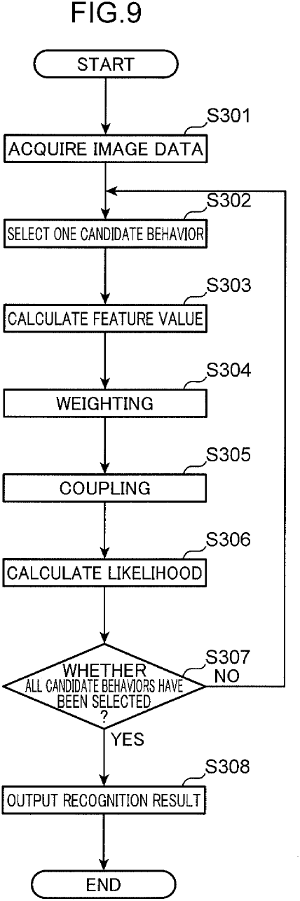

FIG. 9 is a flowchart illustrating an example of behavior recognition processing in the behavior recognition device 1. FIG. 9 illustrates processing when the image data 204 of one frame is captured from one image sensor 2. Thus, for a plurality of image sensors 2, the processing of FIG. 9 is performed in parallel for the image data 204 captured by each image sensor 2. The processing of FIG. 9 may be performed each time the image data 204 of one frame is captured, or may be performed each time the image data 204 of a plurality of frames is captured.

First, the second acquisition unit 103 acquires the image data 204 captured by the image sensor 2, and stores the image data 204 in the memory 200 (step S301).

Next, the recognizer selection unit 110 refers to the list information 205, and selects one candidate behavior among the candidate behaviors associated with the identifier of the image sensor 2 that has captured the image data 204 (step S302). As a result, the candidate behavior corresponding to the space is selected.

Subsequently, the recognizer selection unit 110 refers to the list information 205, and inputs the image data 204 to the recognizer 111 used for recognition of the one candidate behavior to cause the recognizer 111 to calculate a feature value (step S303). The calculated feature value is input to the coupler 121.

Subsequently, the coupler 121 weights the feature value input with a weight coefficient corresponding to the one candidate behavior (step S304).

Subsequently, the coupler 121 couples feature values after being weighted (step S305). The coupled feature values are input to the classifier 122. Subsequently, the classifier 122 calculates likelihood of the feature values received (step S306).

Subsequently, the recognizer selection unit 110 determines whether all the candidate behaviors have been selected (step S307). When all the candidate behaviors have not been selected (NO in step S307), the processing returns to step S302, and likelihood for one candidate behavior selected next is calculated.

In contrast, when all the candidate behaviors have been selected (YES in step S307), the output unit 106 outputs a label of a candidate behavior having the maximum likelihood among likelihoods calculated for the respective candidate behaviors, as a recognition result (step S308). In step S308, labels of k candidate behaviors may be output in descending order of the likelihood other than the label of the candidate behavior having the maximum likelihood. For example, the k of 5 causes top-five classes to be output.

According to the present embodiment described above, a candidate behavior to be a recognition target is selected from among target behaviors based on the position information 203 and the room layout information 202 of the image sensor 2, and then a recognition result for the candidate behavior is calculated. Thus, a behavior of a person depending on a space can be accurately recognized.

### Selection of Recognizer

Next, a method for selecting a recognizer will be described. Conventional methods for recognizing a behavior using a DNN are roughly divided into two types of approach.

A first approach is a method for recognizing a behavior in which a feature value of the behavior is extracted from input data using a plurality of convolutional layers and pooling layers, which are each a versatile feature extraction layer. In this method for recognizing a behavior, likelihood of a given behavior is calculated from the extracted feature value. Unfortunately, this method for recognizing a behavior is not an excellent approach in both calculation cost and recognition accuracy.

A second approach is a method for recognizing a behavior in which a feature value contributing to a behavior to be recognized is heuristically designed, and likelihood of a given behavior is calculated from the feature value extracted as with the first approach. Details of this heuristic design will be described below.

In the image processing field, skeleton information (expression in which joints such as a shoulder and a knee are connected by a straight line) is used as expression of a person, and a circumscribed rectangle (bounding box) is widely used as a position expression of an object. Thus, a heuristic method for recognizing a behavior using the skeleton information or the circumscribed rectangle described above has been proposed. However, both the expression of the skeleton information and the expression of the circumscribed rectangle are each not devised as a feature value of behavior recognition. Thus, the method for recognizing a behavior is determined based on a result of heuristic trial and error. Learning and evaluation of the DNN require a lot of time, so that conditions to be tried are limited. Heuristic trial and error as described above are performed because a behavior to be recognized is identical or similar to a conventional recognition target, and a feature value used in conventional recognition can be referred to. In particular, when a public data set is used for the learning, the behavior to be recognized is in a class defined by the data set.

The conventional method for recognizing a behavior using the DNN also is not an effective approach even when a behavior to be recognized is not included in the conventional recognition target. Therefore, extraction of a feature corresponding to a behavior to be recognized is necessary for efficient behavior recognition. Achieving the efficient behavior recognition requires a configuration capable of determining a method for extracting a feature value when learning data on the behavior to be recognized is given.

The behavior recognition using the DNN is performed to calculate likelihood of the given behavior by processing the sensor data using the DNN. To acquire a label of a single behavior, the label of the behavior having the maximum likelihood is selected. When likelihood of each behavior is calculated through a plurality of DNNs or feature extractors, there is no guarantee that a larger amount of data on the feature value increases recognition accuracy. This is because the feature value probably includes a component that behaves like noise without contributing to recognition accuracy. Similarly, even when the DNNs or the feature extractors to be used increases in number, the accuracy is not necessarily improved. That is, it is important to set the DNNs or the feature extractors in number capable of acquiring information suitable for a behavior to be recognized.

When calculation cost is considered, it is important to select a configuration with the lowest calculation cost from among configurations that achieve desired recognition accuracy. Unfortunately, a typical DNN or feature extractor cannot analytically calculate recognition accuracy because internal processing includes nonlinear transformation. In other words, to obtain the desired recognition accuracy in a certain configuration, there is no method other than preparing a data set and actually performing recognition processing. The calculation cost increases to obtain such recognition accuracy, so that only a limited number of conditions can be tried.

As described above, to use behavior recognition using the DNN having a large calculation cost for real-time processing, the configuration of the DNN or the feature extractor to be used is important.

The calculation cost of a layer (convolutional layer) of the DNN that performs convolution processing will be described below. As with convolution processing in mathematics, the convolutional layer applies a given kernel to input image data to obtain an output. The convolutional layer includes two-dimensional convolution applied to two-dimensional image data on one frame and three-dimensional convolution applied to two-dimensional image data on N-frame (N is the number of frames). Expression (3) is given below in which a parameter number Wc of a weight coefficient of convolution can be expressed with a kernel size indicated as k, the number of dimensions of convolution indicated as d (2 for two-dimensional convolution and 3 for three-dimensional convolution), the number of input channels indicated as Ci, and the number of output channels indicated as Co.

$${W}_{c} = {k}^{d} \times {C}_{i} \times {C}_{o}$$

Expression (4) is given below in which a multiplication number Uc necessary for the convolution calculation can be expressed with the number of strides that is the amount of movement of a kernel and is indicated as s. For simplicity of description, processing is identical in the vertical direction and the horizontal direction of an image.

$${U}_{c} = {W}_{c} \times {\left({C}_{i} / s\right)}^{d}$$

Then, the number Wfc of weight coefficients of the fully connected layer is a product of the number Ci of input channels and the number Co of output channels, as shown in Expression (5).

$${W}_{f c} = {C}_{i} \times {C}_{o}$$

The number of multiplications Ufc necessary for the calculation of the fully connected layer is equal to the number Wfc of weight coefficients, as shown in Expression (6).

$${U}_{f c} = {W}_{f c}$$

The number Wfc of weight coefficients corresponds to the number of memories necessary for execution, and the number of multiplications corresponds to the number of operations necessary for execution. As shown in Expression (5), the number of convolution operations is larger than the total binding by multiplication caused by the kernel. In the case of three-dimensional convolution, both the number of weight coefficients and the number of multiplications increase. Thus, the DNN mainly including a convolutional layer constituted of multiple layers as illustrated in FIG. 2 increases in calculation cost. Even when a graphics process unit (GPU) is used in a desktop computer, processing at 24 fps (corresponding to a general movie), which can be regarded as real-time processing, may be difficult. When a plurality of DNNs are used to improve recognition accuracy, the real-time processing becomes more difficult.

The reason why the conventional DNN has a large calculation cost is that layers constituting a network are mainly arranged in series, and most of the layers are constituted of convolutional layers. The network includes an intermediate layer that also has a large number of weight coefficients, so that the number of multiplications also increases. The intermediate layer outputs a tensor that is difficult for a person to interpret, and thus the intermediate layer does not necessarily output an optimum expression for recognition. In other words, the intermediate layer has more weight coefficients than necessary, so that the number of multiplications also increases. That is, when a behavior of a person or a state of a space is effectively expressed with a small number of parameters in the intermediate layer, the number of weight coefficients and the number of multiplications can be reduced.

In consideration of when a behavior of a person is identified, the behavior can be estimated also from the skeleton information on the person instead of an input image being dense data. For example, a behavior of cutting an ingredient with a kitchen knife is repetition of a characteristic up-down movement of a hand. The number of data (the number of bytes) required to express the input image data is a product of a vertical length, a horizontal length, and the number of channels of the image data, for 8-bit image data. In contrast, two-dimensional skeleton information can be expressed by 34 pieces of data that are a product of the number of vertices (e.g., 17 points) of the skeleton and the number of components of coordinate data (x, y) of the vertices of the skeleton.

In consideration of the above, a method for selecting the recognizer 111, according to the embodiment of the present invention, will be described below. For example, behaviors of a person to be a recognition target include not only an action such as walking, running, standing, talking, cleaning, or starting cooking, but also a stationary action such as sleeping, lying, sitting, or watching television.

First, many choices of selecting the recognizer 111 will be described. The number of recognizers 111 used in the first behavior recognition unit 104 is at least one. When M recognizers 111 are selected from among N recognizers 111 held by the first behavior recognition unit 104, a combination of the recognizers 111 is on the order of the factorial of N. The order of the factorial of N diverges faster than an exponential function. In consideration of learning time, N larger than about 5 causes difficulty in learning all combinations of the recognizers 111.

Next, a problem related to the combination of the recognizers 111 is expressed as a mathematical problem. Performing learning for each combination of the selected recognizers 111 enables obtaining recognition accuracy and calculation cost. Searching a combination minimizing the calculation cost while satisfying the recognition accuracy (e.g., 70%) that is given to be satisfied is a combinatorial optimization problem with conditions. This kind of combinatorial optimization problem cannot be solved analytically when the combinations increase in number to cause difficulty in performing full search. Thus, a quasi-optimum solution is to be searched. There is no universal algorithm for the combinatorial optimization problem.

Then, the recognizer 111 is selected based on previous knowledge and a greedy method to efficiently search for the selection of the recognizer 111.

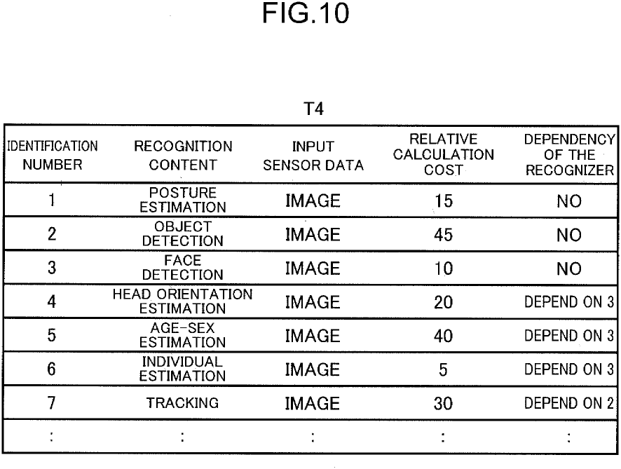

First, the previous knowledge will be described. FIG. 10 is a diagram illustrating a data configuration of the previous knowledge table T4 summarizing information on the recognizer 111. This table is stored in the memory 200. The previous knowledge table T4 has items related to an identification number of the recognizer 111, recognition content, input sensor data, relative calculation cost, and dependency of the recognizer. Each item will be described. The recognizer 111 registered is provided with an identification number without duplication (e.g., serial numbers), the identification number serving as an index or a hash in combination search. The recognition content is recognized by the recognizer 111. The input sensor data is required for the recognizer 111 to perform inference, and is zero or more in number. Zero input senor data is included because the recognizer 111 performing inference only with a feature value calculated by another dependent recognizer 111 does not require sensor data. The relative calculation cost is a relative value of the calculation cost of the recognizer 111. The relative calculation cost is a relative value calculated based on a reference result of a benchmark executed by a calculator. The relative calculation cost may be calculated based on benchmark results of a plurality of calculators, or an absolute value of the benchmark result itself may be used as the relative calculation cost.

The dependency of the recognizer is information indicating whether the recognizer is dependent on another recognizer 111. For example, the recognizers 111 with the identification numbers of 4 to 6 depend on the recognizer 111 with the identification number of 3. This is because a result of the face detection is used when the head orientation estimation, the age-sex estimation, and the individual estimation are performed.

The recognizer 111 that detects a specific area of a person, such as the recognizer 111 that detects a hand or a foot, may be used. The recognizer 111 that outputs dense data, such as a mask indicating a range of an image, may be also used.

Next, the greedy method will be described. The greedy method is of making the best selection based on partial information. Selection of the recognizer 111 is first performed such that recognition accuracy when only one recognizer 111 is selected is calculated using the learning data for each recognizer 111 included in the previous knowledge table T4. When one recognizer 111 has high recognition accuracy by being only used, high recognition accuracy is also expected when the one recognizer 111 is used in combination with another recognizer 111. However, there is no guarantee thereof. In the greedy method, a priority order of a combination of the recognizers 111 to be evaluated is determined by assuming that when one recognizer 111 has high recognition accuracy by being only used, recognition accuracy is also high when the one recognizer 111 is used in combination with another recognizer 111. Specifically, the recognizers 111 are sorted in descending order of recognition accuracy when only one recognizer 111 is used, and are preferentially evaluated from the head recognizer 111. For example, when indexes are sequentially assigned by defining the head recognizer 111 as a first recognizer 111, an index close to the head, such as 1 and 2, 1 and 3, 1 to 3, or 1 to 4, is preferentially used. A more detailed method for selecting an index can be expressed by a parameter X in consideration from the head to the X-th index and a parameter Y allowing selection of up to Y indexes. The parameters of X and Y are determined in accordance with performance of a computer that executes inference, and are determined as X = 4 and Y = 3, for example. The recognizer selection table T2 illustrated in FIG. 5 is created based on the selection result of the recognizer 111 as described above, for example.

### Selection of Classifier

Next, selection of the classifier 122 will be described. The first behavior recognition unit 104 outputs a feature value that is data obtained by vectorizing a small number of parameters like skeleton information, so that the feature value can be identified without using the CNN. The classifier 122 has a significantly smaller amount of calculation processing than the CNN. A plurality of classifier candidates may be subjected to cross-validation to select the classifier 122 having the maximum accuracy or F1 score. Examples of the candidate classifier 122 include a classifier using logistics regression, a support vector machine (SVM), a decision tree, a random forest, a k-nearest neighbor algorithm, a Gaussian naive Bayes, a perceptron, or a stochastic descent method.

### Learning of Classifier

Next, learning of the classifier 122 will be described. The classifier 122 may learn using learning data including a label of a target behavior. For example, image data on a moving image serving as learning data is prepared for each of labels of “starting cooking” and “not starting cooking”. The behavior recognition processing illustrated in FIG. 9 is performed by the behavior recognition device 1 using the prepared image data, and an obtained label is compared with a correct answer label of the learning data. Then, weight of the classifier 122 is updated to minimize a deviation between the labels.

### Simulation

Next, a simulation performed by the behavior recognition device 1 to check whether the amount of calculation processing is smaller than that of existing behavior estimation AI will be described.

This simulation was performed by using a CNN as the existing recognizer 111. Specifically, “1: PoseNet” was used as the recognizer 111 for the posture estimation, “2: SSD” was used as the recognizer 111 for the object detection, “3: RetinaFace” was used as the recognizer 111 for the face detection, and “4: DeepHeadPose” was used as the recognizer 111 for the head orientation estimation. As the classifier 122, a classifier of a stochastic descent method was used. Then, “5: RepresentationFlowNet” was used as the existing behavior estimation AI.

As the input image data, one piece of color image data including three persons was used. This image data had a resolution of 640 × 480, three channels, and a resolution of 8 bits. The classifier 122 had calculation cost that was ignored because it was sufficiently smaller than that of the existing recognizer 111 regardless of the number of classes to be identified.

As a calculator, a desktop type personal computer including calculation assistance by a graphics process unit (product model number: Geforce GTX 1080 Ti) was used.

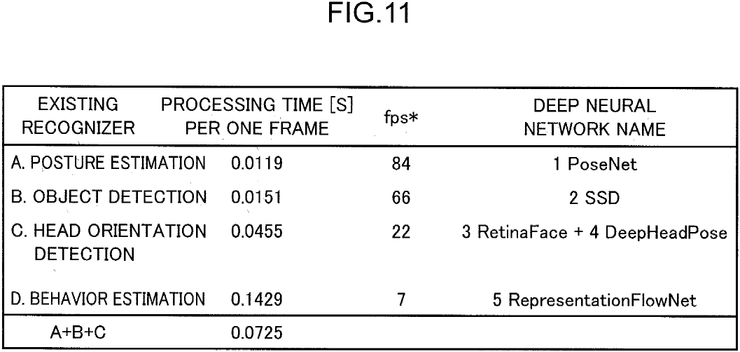

FIG. 11 is a table summarizing a processing time per frame when the existing recognizers 111 were individually executed. The simulation was performed to measure processing time when each of the recognizers 111 of processing A (posture estimation), processing B (object detection), and processing C (head orientation detection) in FIG. 11 was executed. The processing time of the processing C includes the processing time of the head orientation estimation and the face detection. The processing A, processing B, and processing C were independent of each other, and thus were able to be executed in parallel. When overhead was ignored, the maximum value of the processing time among the processing A, processing B, and processing C was 0.0455 seconds of the processing C. Then, the entire processing time was 0.0725 seconds when the processing A, processing B, and processing C were sequentially performed.

In contrast, processing time of processing D (existing behavior estimation AI) was 0.1429 seconds. Thus, processing speed when the processing A, processing B, and processing C were performed in parallel was three times faster than that of the processing D. Then, processing speed when the processing A, processing B, and processing C were sequentially performed was twice faster than that of the processing D. As described above, it has been verified that using the plurality of recognizers 111 has a significantly faster processing speed than using the existing behavior estimation AI.

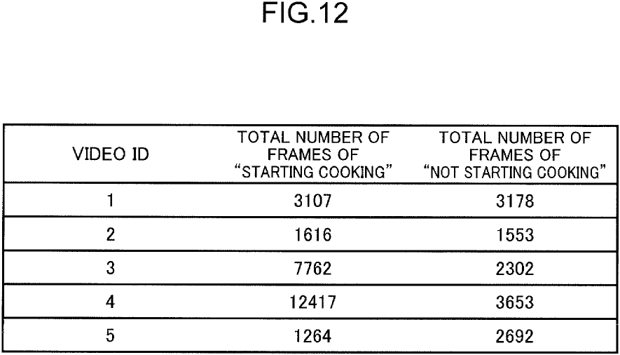

Next, a simulation performed to evaluate recognition accuracy of the behavior recognition device 1 will be described. This simulation used image data on five moving images illustrated in FIG. 12 as input image data. FIG. 12 is a table summarizing the input image data. A video ID is an identifier for identifying the five moving images. FIG. 12 also shows a total number of frames of the “starting cooking” and a total number of frames of the “not starting cooking” for each moving image.

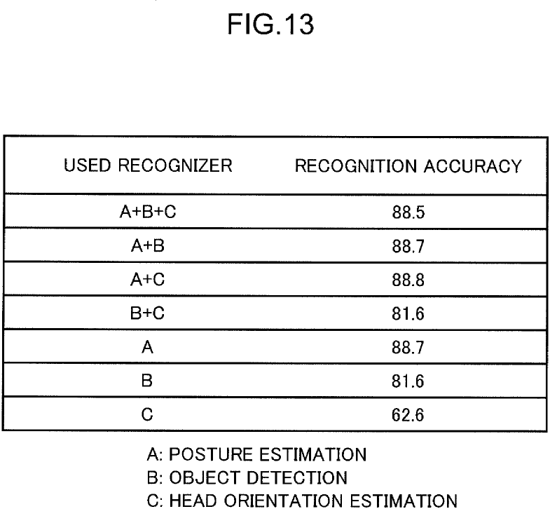

FIG. 13 is a table summarizing results of the simulation performed to evaluate the recognition accuracy of the behavior recognition device 1. For example, FIG. 13 shows processing “A+B+C” indicating that the first behavior recognition unit 104 includes the recognizer 111 of the processing A, the recognizer 111 of the processing B, and the recognizer 111 of the processing C, and processing “A+B” indicating that the first behavior recognition unit 104 includes the recognizer 111 of the processing A and the recognizer 111 of the processing B. This simulation was performed such that the recognition accuracy and processing time of each of eight types of classifier 122 were measured for each of combinations of the corresponding processing A to processing C illustrated in FIG. 13. The eight types of classifier 122 are of the logistics regression, the support vector machine, the decision tree, the random forest, the k-nearest neighbor algorithm, the Gaussian naive Bayes, the perceptron, and the stochastic descent. This simulation had a result in which using the classifier 122 of the stochastic descent method had not only the shortest processing time but also the maximum recognition accuracy, among the eight types of classifier 122.

Using the classifier 122 of the probabilistic descent method had an average value of 88.5% of the recognition accuracy among the combinations of the corresponding processing A to processing C illustrated in FIG. 13. This result indicates that the recognition accuracy of the behavior recognition device 1 was higher than 50% that is an expectation value of the recognition accuracy when two-class classification of the “starting cooking” and the “not starting cooking” is randomly estimated. Thus, this simulation result shows that the behavior recognition device 1 being capable of recognizing the behavior was verified.

Among the combinations shown in FIG. 13, the processing “A+C” has the best recognition accuracy of 88.8%. However, only the processing A obtained the recognition accuracy of 88.7%. When a threshold of the recognition accuracy is assumed as 88.7%, the calculation cost was minimized when only the processing A was used. The processing “A+B+C” was not the best because the recognizer 111 without contributing to improvement of accuracy was used, and the recognizer 111 behaved like a noise source.

The above simulation result is an example, and each of the recognizers 111 constituting the first behavior recognition unit 104 is not limited to the above-described one, and an optimal recognizer 111 is appropriately used in accordance with a target behavior. Additionally, the classifier 122 of other than the stochastic descent method may be used.

### Modification

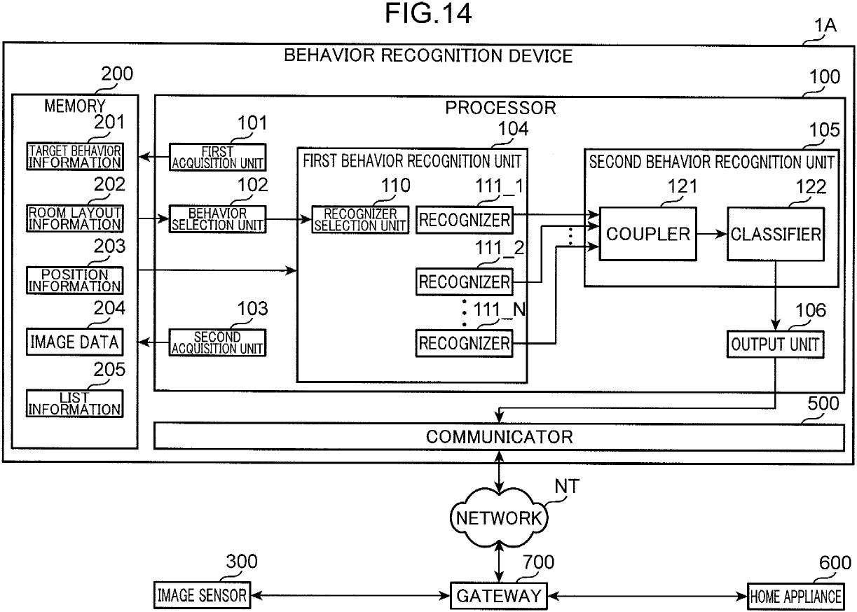

(1) Although the behavior recognition device 1 is formed alone in the above embodiment, the present disclosure is not limited thereto, and thus the behavior recognition device 1 may be formed by a plurality of devices. FIG. 14 is a block diagram illustrating an example of a configuration of a behavior recognition device 1A according to a modification of the present disclosure. The behavior recognition device 1A includes a server. The behavior recognition device 1A further includes a communicator 500. The communicator 500 transmits a recognition result output from an output unit 106 to a home appliance 600 via a network NT and a gateway 700. The communicator 500 receives image data captured by an image sensor 300 installed in the home. The network NT is a wide-area communication network such as the Internet, for example. The gateway 700 is installed in the home, and connects the image sensor 300 and the home appliance 600 to the network NT. The home appliance 600 is a washing machine, a microwave oven, a television, or the like. The home appliance 600 performs control using the recognition result of the behavior transmitted from the behavior recognition device 1A and displays the recognition result. As described above, even the behavior recognition device 1A including the server can recognize a behavior of a person in the home.
(2) Although image data is used as input data in the above embodiment, besides this, at least one of thermal image data, depth image data, audio data, room temperature data, humidity data, illuminance data, and wireless radio wave data may be used.
(3) When a behavior of the person in the home is recognized by a camera installed in the home, it is assumed that an installation position and an angle of the camera are fixed or changed at a low frequency. The camera with a wide-angle lens has a viewing angle of about 110°, and the camera with a narrow-angle lens has a viewing angle less than or equal to the viewing angle of about 110°. Then, a range reflected in a certain camera is a part of the installed space. Thus, it is assumed that the camera is installed to be able to photograph a space having high occurrence frequency of a behavior desired to be recognized or high importance at the time of an occurrence of the behavior. The recognition accuracy of the behavior is improved as long as a space provided with the camera and an object that is reflected in the camera or is likely to be reflected in these assumptions, can be known in advance. For example, a behavior having an occurrence frequency of zero can be excluded from recognition targets. When a sofa with a low movement frequency is reflected in the camera, it is assumed that a behavior of sitting on the sofa has a high occurrence frequency. When a movable chair exists in the space, it is assumed that a behavior of sitting on the chair has a high frequency. As a result, a value of the weight coefficient of the weight table T3 illustrated in FIG. 6 can be determined.

Interaction between a person and an object is important in behavior recognition in a home, examples of the interaction including direct contact between the person and the object, and the person existing near the object. When an installation position of an object (first object to be described later) involving movement, opening, closing, and operation is known, the behavior recognition is determined based on a positional relationship between the person and the object or orientation of the person with respect to the object. This is because the person often moves, opens, closes, and operates the object during the behavior.

A non-movable facility (second object to be described later) in the home represented by a plumbing facility is also important in the behavior recognition. Behaviors using water, such as cooking and washing, usually uses equipment installed in the home. Thus, the behavior recognition is determined based on a positional relationship between the plumbing facility and the person. This is because a behavior requiring water has a high frequency in life of the person.

A house is generally partitioned into about four to ten rooms with doors or fixed or movable walls. A multilayer house also includes a lifting facility such as a staircase. Thus, the house includes an object (a third object described later) including a plurality of spaces and a plurality of doors. Behavior recognition is based on names of these spaces, and a positional relationship between the doors or the lifting facility, and the person. This is because there is a behavior to be performed only in a specific room, such as cooking or bathing.

As described above, information on where the object or facility is and how the space is partitioned is important in the behavior recognition. Although there is a conventional technique of performing behavior recognition in consideration of a space name such as a living room or a bedroom, only the space name of the living room or the bedroom is insufficient to determine the behavior because the same space name is used in various ways. Thus, it is important to consider what kind of interaction between the person and an object can occur in which space. Based on the above, a modification (3) of the present disclosure will be described below.

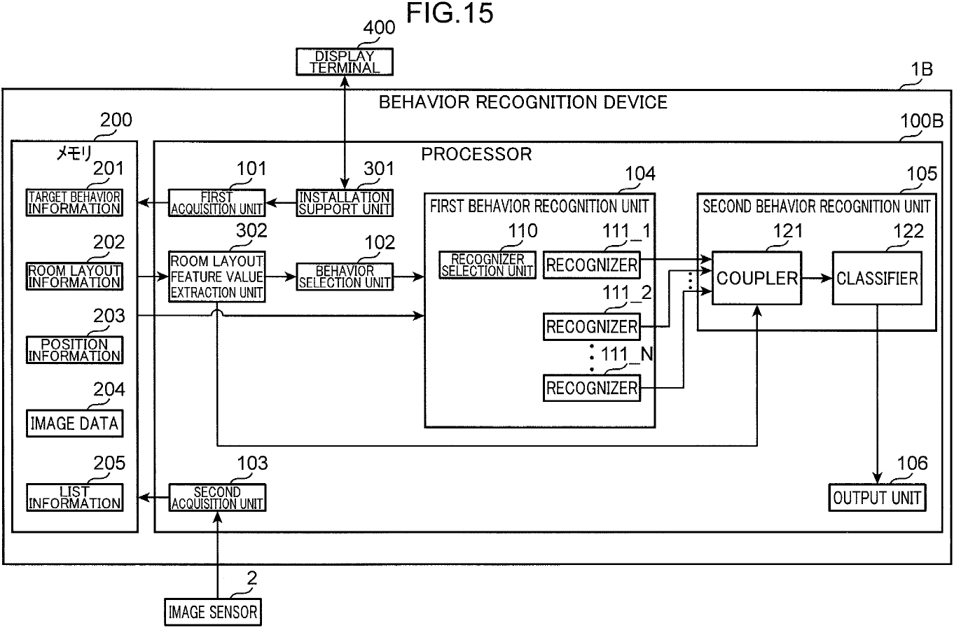

FIG. 15 is a block diagram illustrating an example of a configuration of a behavior recognition device 1B according to the modification (3) of the present disclosure. This modification includes a behavior selection table T1 that is created based on a room layout feature value that is extracted based on room layout information 202. The room layout information 202 in this modification includes information (type information and position information) on objects (facilities and devices) installed in each of spaces in a building in addition to information on the spaces.

The behavior recognition device 1B is communicably connected to a display terminal 400 via a predetermined communication path. Applicable examples of the predetermined communication path include a wireless LAN and Bluetooth (registered trademark). The predetermined communication path may be the Internet. Examples of the display terminal 400 include a smartphone and a tablet computer. The display terminal 400 is carried by a user, for example. The user is a contractor of an image sensor 2, for example. The contractor is a resident of a house or a contractor, for example.

The behavior recognition device 1B includes a processor 100B that further includes an installation support unit 301 and a room layout feature value extraction unit 302 with respect to the processor in FIG. 1. The room layout feature value extraction unit 302 extracts objects installed in the building based on the room layout information 202 to classify the extracted objects into any one of a movable first object, a second object that is a plumbing facility, and a third object that is a structure of the building, and then extracts a room layout feature value in which each of the classified objects is associated with classification information indicating an installation position and a classification result of the corresponding one of the classified objects. The room layout feature value is defined by a two-dimensional table, for example.

The first object includes a movable object such as furniture and an electrical appliance, for example. Specifically, the first object is a vacuum cleaner, a coffee maker, a laptop computer, a chair, a sofa, or the like.

The second object is a non-movable plumbing facility such as a sink and a washbasin, for example.

The third object is a structure of the building such as an entrance, a kitchen, a living room, a dining room, a bedroom, a bathroom, a lifting facility, or a lavatory.

The installation position is defined by two-dimensional or three-dimensional coordinate data with respect to the entrance of the building, for example. The installation position of the third object may be defined by coordinate data indicating a region where the third object is located. This coordinate data enables determining in which space in the building the first object and the second object are installed. The installation positions of the first object and the second object may include names of spaces of the building in which the first object and the second object are located, in addition to the coordinate data indicating the positions of the first object and the second object.

The classification information indicates an object that corresponds to which of the first object to the third object, the object being extracted from the room layout information 202.

The room layout feature value extraction unit 302 generates the behavior selection table T1 based on the extracted room layout feature value.

For example, the installation position of the first object indicates a position where the user operates. For example, an installation position of a coffee maker can be associated with a behavior of brewing coffee. For example, an installation position of a microwave oven can be associated with a behavior of starting cooking performed by the user.

The second object is a plumbing facility, so that the installation position of the second object indicates a position where operation using water is performed. For example, an installation position of a sink can be associated with a behavior of washing a dish.

The installation position of the third object indicates a name of a space, entry and exit of the user into and from the space, and a movable range of the user. For example, an installation position of a door of a bathroom can be associated with bathing operation.

The room layout feature value extraction unit 302 generates the behavior selection table based on the extracted room layout feature value. As illustrated in FIG. 4, the behavior selection table T1 shows one or more spaces in the building that are each associated with a target behavior that is likely to be performed by a user in the corresponding one of the spaces.

Here, the room layout feature value extraction unit 302 may determine what kind of device or facility is installed in each space from the room layout feature value, and generate the behavior selection table T1 by referring to a rule predetermined from the determination result and the classification information. Applicable examples of the rule include a rule in which a device or equipment is associated with a target behavior that is likely to be performed in the device or equipment, such as warming a dish that is associated with a microwave oven being the first object, brewing coffee that is associated with a coffee maker being the first object, and washing a dish that is associated with a sink being the second object.

For example, it is assumed that the microwave oven, the coffee maker, and the sink are installed in the kitchen. This case causes the room layout feature value extraction unit 302 to generate the behavior selection table T1 in which target behaviors such as the starting cooking, the brewing coffee, and the washing a dish are associated with the kitchen. Similarly, the room layout feature value extraction unit 302 may associate a target behavior with another space in the building.

The rule may include a target behavior that is highly likely to be performed on not only the device or facility but also the space itself. As described with reference to FIG. 4, applicable examples of the rule include rules such as the starting cooking that is associated with the kitchen, washing that is associated with the lavatory, reading that is associated with the living room, the dining room, and the bedroom, eating that is associated with the living room and the dining room.

The room layout feature value extraction unit 302 also may set a weight coefficient described in the weight table T3 illustrated in FIG. 6 from the extracted room layout feature value. For example, when a sink, a refrigerator, a microwave oven, and a cooking stove are installed in the kitchen, the weight coefficient We for the kitchen may be set to 1 for the sink, the refrigerator, the microwave oven, and the cooking stove, and may be set to 0 otherwise.

The room layout feature value extraction unit 302 may set the weight coefficient We also for other spaces other than the kitchen, as in the kitchen.

The first acquisition unit 101 may acquire the behavior selection table T1 generated in this manner as the target behavior information.

The installation support unit 301 further includes an installation support unit that acquires a name of a space of the building provided with the image sensor 2 using the display terminal 400, and outputs installation guidance to the display terminal 400, the installation guidance being for installing the image sensor 2 with the field of view including a specific device or a specific facility related to the space.

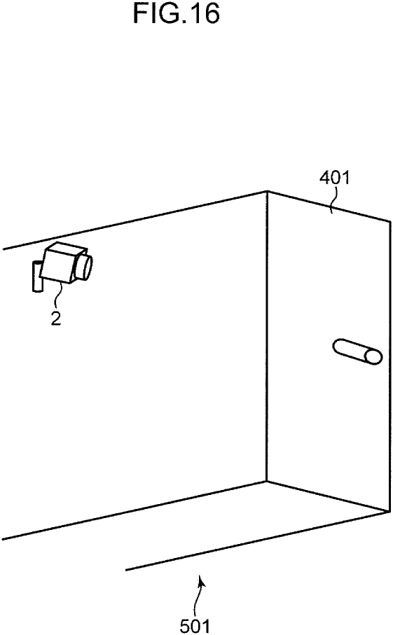

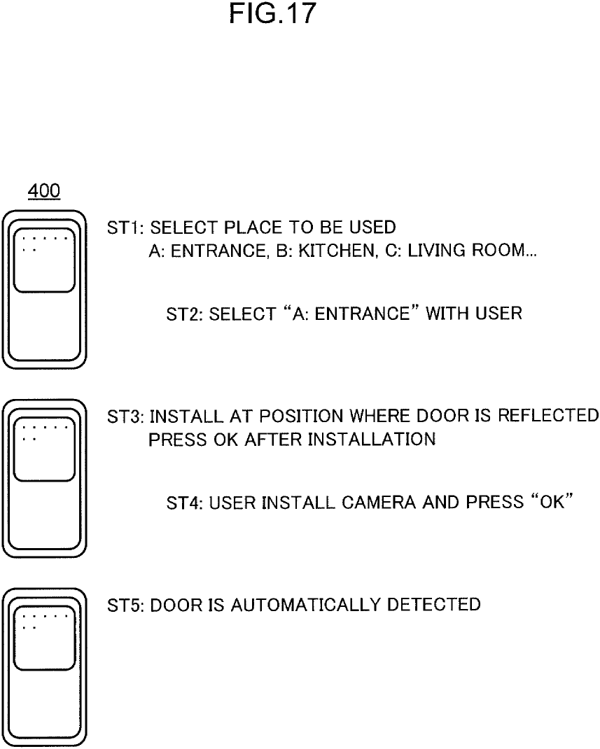

FIG. 16 is a diagram illustrating a scene in which the image sensor 2 is installed at an entrance 501. FIG. 17 is a diagram illustrating an example of interaction between the user and the display terminal 400 in the scene where the image sensor 2 is installed at the entrance 501.

In step ST1, the display terminal 400 receives operation of opening a setting screen from the user, and displays a list of spaces in each of which the image sensor 2 is scheduled to be installed. Here, names of the spaces in which the image sensors 2 are to be installed are displayed in a list such as A: entrance, B: kitchen, C: living room,....

In step ST2, the display terminal 400 receives operation of the user for selecting the name of the space in which the image sensor 2 is installed from the list of the names of the spaces. The display terminal 400 transmits the name of the selected space to the behavior recognition device 1B. Here, the image sensor 2 is installed at entrance 501, so that the “A: entrance” is selected.

In step ST3, the display terminal 400 displays a voice message to prompt the user to install the image sensor 2, such as “Install the display terminal at a position where the door is reflected, and press OK after installation”. The display terminal 400 has a setting screen in which an OK button is displayed along with this message, the OK button being for notifying that the user has completed installation work of the image sensor 2.

This installation work causes the image sensor 2 to be installed at the entrance 501 as illustrated in FIG. 16.

In step ST4, the display terminal 400 receives operation of the user for pressing the OK button. The display terminal 400 having received the operation of pressing the OK button transmits information indicating that the OK button has been pressed to the behavior recognition device 1B.

The installation support unit 301 having acquired the information indicating that the OK button has been pressed acquires image data captured by the image sensor 2, and performs processing of detecting a door 401 from the acquired image data. At this time, the installation support unit 301 causes the display terminal 400 to display a message, “Door is automatically detected” (step ST5). Here, the installation support unit 301 may detect the door 401 using a predetermined recognizer. The door 401 is an example of the specific facility at the entrance 501. The specific facility is determined in advance in accordance with the space in which the image sensor 2 is installed. As the predetermined recognizer, a recognizer prepared in advance for detecting the door 401 is used, for example.

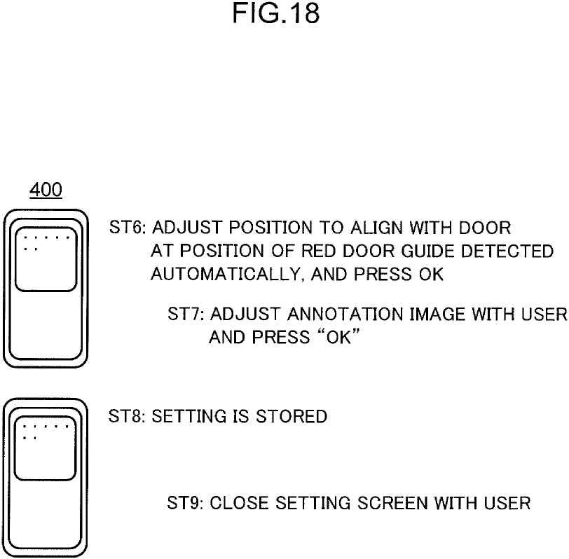

FIG. 18 is a diagram illustrating interaction subsequent to FIG. 17. In step ST6, the display terminal 400 acquires annotation information indicating the detection result of the door 401 from the installation support unit 301, and displays a setting screen for superimposing and displaying an annotation image indicated by the acquired annotation information on the image captured by the image sensor 2. The setting screen displays a message prompting correction of the annotation image, such as “adjust position to align with door at position of red door guide detected automatically, and press OK”. The annotation information is coordinate data on the annotation image, for example.

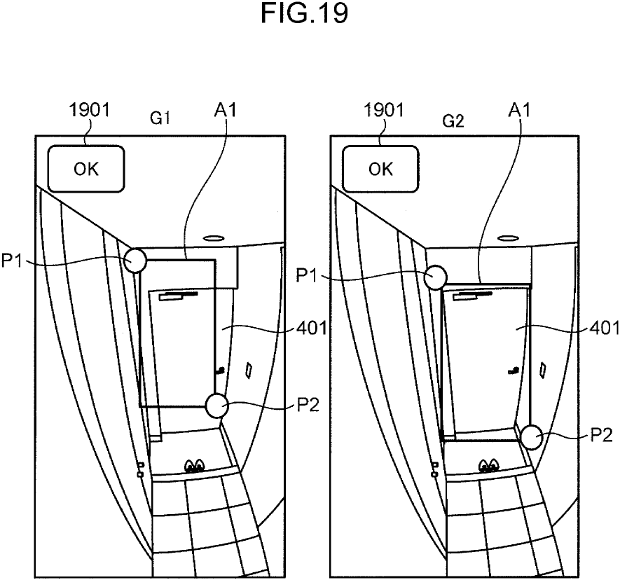

FIG. 19 is a diagram illustrating an example of setting screens G1 and G2 on each of which an annotation image A1 is superimposed. The setting screen G1 indicates the annotation image A1 before correction, and the setting screen G2 displays the annotation image A1 after the correction. The annotation image A1 is defined by a rectangular bounding box. The annotation image A1 has a predetermined color (here, red). The setting screens G1 and G2 each display an OK button 1901 that notifies completion of correction work of the annotation image A1.

The annotation image A1 has an upper left vertex at which a circle mark P1 is displayed, and a lower right vertex at which a circle mark P2 is displayed.

When receiving operation of moving the circle marks P1 and P2, the display terminal 400 changes the annotation image A1 in size in conjunction with the received operation.

The setting screen G1 displays the annotation image A1 that is a detection result of the door 401 with the recognizer. The annotation image A1 is displaced to the left obliquely upward of the door 401, and thus it can be seen that the door 401 is not correctly recognized.

The user inputs operation of moving the circle marks P1 and P2 to cause the annotation image A1 to have a shape of a circumscribed rectangle of the door 401. The operation causes the setting screen G2 to be obtained. The setting screen G2 displays the annotation image A1 positioned in the circumscribed rectangle of the door 401.

Thus, the annotation image A1 displayed at the position displaced from the door 401 on the setting screen G1 is corrected to cause the entire area of the door 401 to be surrounded as illustrated in the setting screen G2. As a result, even when the recognizer cannot accurately recognize the position of the door 401 on the image, the recognizer can obtain a correct position of the door 401 on the image.

In step ST7, the display terminal 400 receives operation of pressing the OK button 1901 from the user having completed adjustment of the annotation image A1. The display terminal 400 having received the operation transmits coordinate data on the corrected annotation image A1 to the installation support unit 301. The installation support unit 301 having received the coordinate data stores the coordinate data on the corrected annotation image A1 in the memory 200 in association with position information 203 of the image sensor 2 installed at the entrance 501.

After that, the recognizer 111 for recognizing the target behavior corresponding to the entrance 501 recognizes a behavior of the user with respect to the image data captured by the image sensor 2 installed at the entrance 501 based on the annotation image A1 indicated by the coordinate data. This configuration enables the recognizer 111 to efficiently recognize a behavior of the user.

In step ST8, the display terminal 400 receives information indicating that the coordinate data is stored from the installation support unit 301, and thus displays a message, “Setting is stored”.

In step ST9, the display terminal 400 receives operation of closing the setting screen from the user. Consequently, the display terminal 400 closes the setting screen.

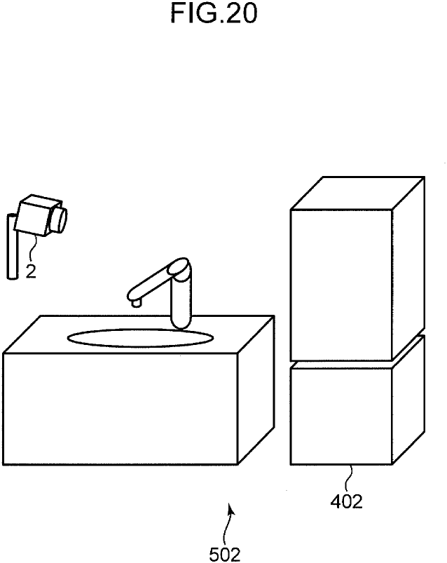

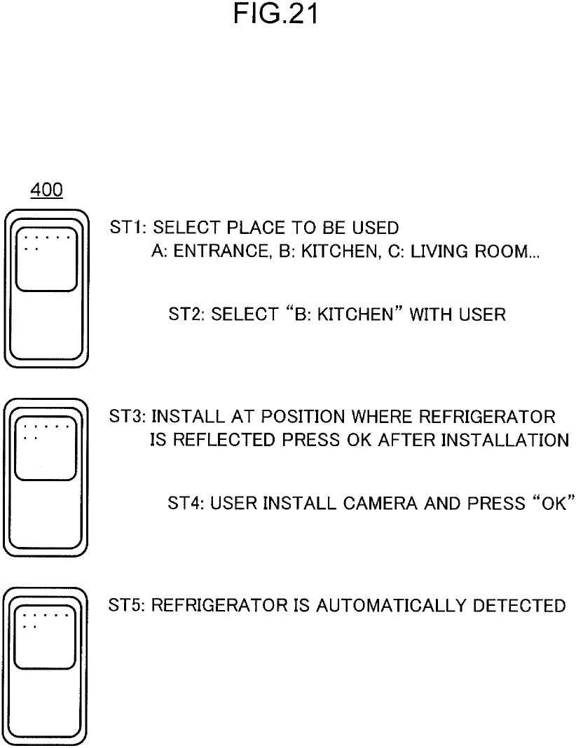

FIG. 20 is a diagram illustrating a scene in which the image sensor 2 is installed in a kitchen 502. FIG. 21 is a diagram illustrating an example of interaction between the user and the display terminal 400 in the scene where the image sensor 2 is installed in the kitchen 502.

Step ST1 is the same as step ST1 in FIG. 17. In step ST2, the display terminal 400 receives operation of selecting the “B: kitchen” as the installation location of the image sensor 2 from the user.

Step ST3 is the same as step ST3 in FIG. 17. In step ST4, the display terminal 400 receives operation of the user for pressing the OK button. The display terminal 400 having received the operation of pressing the OK button transmits information indicating that the OK button has been pressed to the behavior recognition device 1B.

The installation support unit 301 having acquired the information indicating that the OK button has been pressed acquires image data captured by the image sensor 2, and performs processing of detecting a refrigerator 402 from the acquired image data. Then, the installation support unit 301 causes the display terminal 400 to display a message, “Refrigerator is automatically detected” (step ST5). Here, the installation support unit 301 may detect the refrigerator 402 using a predetermined recognizer. The refrigerator 402 is an example of a specific device in kitchen 502. The specific device is determined in advance in accordance with the space in which the image sensor 2 is installed. As the predetermined recognizer, a recognizer prepared in advance for detecting the refrigerator 402 is used, for example.

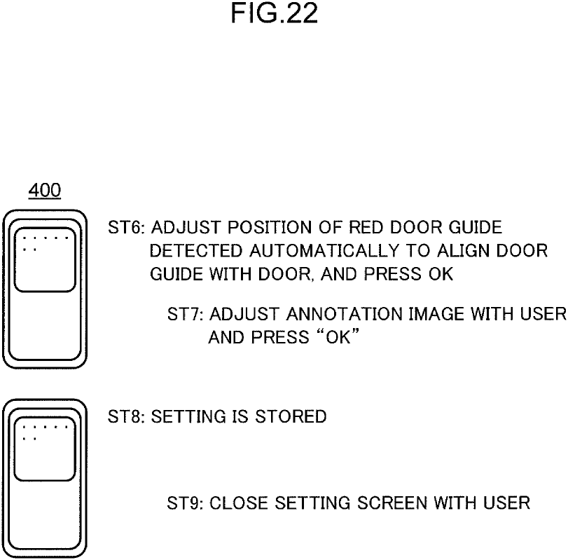

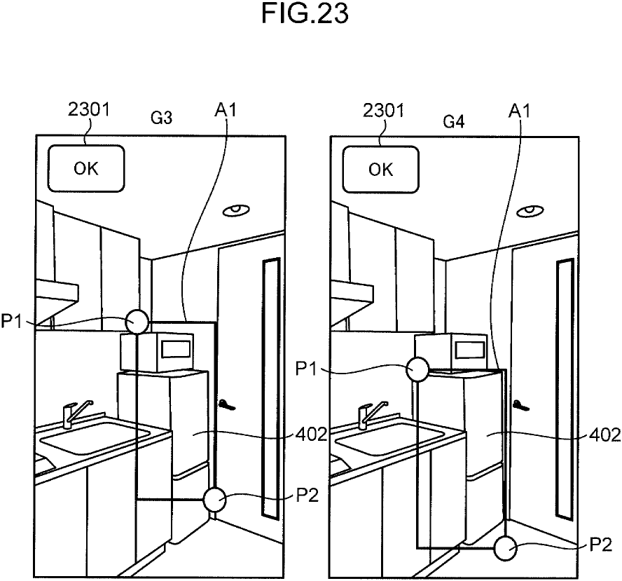

FIG. 22 is a diagram illustrating interaction subsequent to FIG. 21. Steps ST6 to ST9 are the same as those in FIG. 18. FIG. 23 is a diagram illustrating an example of setting screens G3 and G4 on each of which an annotation image A1 is superimposed. The setting screen G3 displays the annotation image A1 before correction, and the setting screen G4 displays the annotation image A1 after the correction. The setting screen G3 displays the annotation image A1 that is a detection result of the refrigerator 402 with the recognizer. The annotation image A1 is displaced upward from the refrigerator 402, and thus it can be seen that the refrigerator 402 is not correctly recognized. The user inputs operation of moving circle marks P1 and P2 to cause the annotation image A1 to have a shape of a circumscribed rectangle of the refrigerator 402. The operation causes the setting screen G4 to be obtained. The setting screen G4 displays the annotation image A1 positioned in the circumscribed rectangle of the refrigerator 402.

Thus, the annotation image A1 displayed at the position displaced from the refrigerator 402 on the setting screen G3 is corrected to cause the entire area of the refrigerator 402 to be surrounded as illustrated in the setting screen G4. As a result, even when the recognizer cannot accurately recognize the position of the refrigerator 402 on the image, a correct position of the refrigerator 402 on the image can be obtained.

After that, the recognizer 111 for recognizing the target behavior corresponding to the refrigerator 402 recognizes a behavior of the user with respect to the image data captured by the image sensor 2 installed at the refrigerator 402 based on the annotation image A1 indicated by the coordinate data. This configuration enables the recognizer 111 to efficiently recognize a behavior of the user.

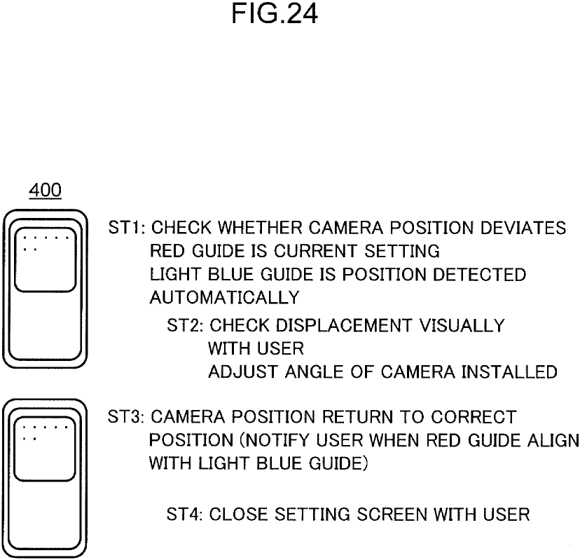

FIG. 24 is a diagram illustrating an example of interaction between the user and the display terminal 400 when the annotation image A1 is corrected after the image sensor 2 is installed. The image sensor 2 may be changed in angle due to some external force applied after installation. In this case, the coordinate data indicated by the annotation image A1 set at the time of installation deviates from a position of a specific device or a specific facility on the image. To correct this deviation, the following correction work is performed.

In step ST1, the display terminal 400 receives operation of opening the setting screen from the user, and displays a message prompting verification of positional deviation of the image sensor 2. Here, a message, “Check whether camera position deviate. Red guide is current setting. Light blue guide is position detected automatically”, is displayed.

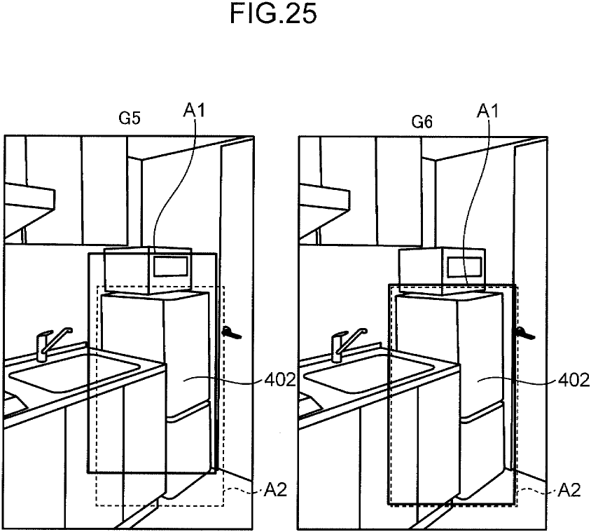

FIG. 25 is a diagram illustrating an example of setting screens G5 and G6 on each of which an annotation image A1 is displayed in a superimposed manner. The setting screen G5 indicates the annotation image A1 before correction, and the setting screen G6 indicates the annotation image A1 after the correction. The annotation image A1 corresponds to a red guide. The annotation image A2 illustrated with a dotted line indicates a detection result of the refrigerator 402 with a recognizer. The annotation image A2 corresponds to a light blue guide.

The setting screen G5 displays the annotation image A1 that is displaced upward with respect to the annotation image A2 because the image sensor 2 is at an angle that deviates from an angle at the time of installation.

In step ST2, the user checks the deviation of the angle of the image sensor 2 from the setting screen G5, and performs adjustment work of the angle of the image sensor 2.

The display terminal 400 determines whether the annotation image A1 coincides in position with the annotation image A2 by image processing. When determining that the images coincide in position with each other, display terminal 400 displays a message indicating that the angle of the image sensor 2 returns to the angle at the time of installation.

In step ST4, the display terminal 400 receives operation of closing the setting screen from the user. Consequently, the display terminal 400 closes the setting screen.

Causing the user to perform such adjustment work enables even the image sensor 2 changed in angle after installation to return to a state at the angle at the time of installation. This adjustment work enables the recognizer 111 to accurately recognize a behavior of the user.

### Industrial Applicability

The behavior recognition device of the present invention is useful for recognizing a behavior of a person in a building.

1. A behavior recognition device that recognizes a behavior of a person in a building, the behavior recognition device comprising:
a first acquisition unit that acquires target behavior information including one or more target behaviors that are each to be a predetermined recognition target, room layout information on the building, and position information on an image sensor installed in the building;
a behavior selection unit that selects a candidate behavior that is a recognition candidate from among the one or more target behaviors included in the target behavior information based on the position information on the image sensor and the room layout information;
a second acquisition unit that acquires image data detected by the image sensor;
a first behavior recognition unit that determines one or more recognizers corresponding to the candidate behavior and calculates a feature value of the image data using the one or more recognizers;
a second behavior recognition unit that recognizes the candidate behavior based on the feature value; and
an output unit that outputs a recognition result acquired by the second behavior recognition unit.

2. The behavior recognition device according to claim 1, wherein
the first behavior recognition unit determines a plurality of recognizers when the candidate behavior is a predetermined behavior, and
the second behavior recognition unit combines feature values calculated by the plurality of recognizers to recognize the candidate behavior based on the combined feature values.

3. The behavior recognition device according to claim 2, wherein the predetermined behavior is cleaning, brushing teeth, cooking, washing, using a computer, reading, or eating.

4. The behavior recognition device according to claim 1, wherein
each of the recognizers is constituted of a convolution neural network, and
the second behavior recognition unit recognizes the candidate behavior using a classifier using any one of logistics regression, a support vector machine, a decision tree, random forest, a k-nearest neighbor algorithm, Gaussian naive Bayes, a perceptron, and a stochastic descent method.

5. The behavior recognition device according to claim 1, wherein the second behavior recognition unit recognizes the candidate behavior using a classifier that is machine-learned with the feature value as an explanatory variable and the target behavior as an objective variable.

6. The behavior recognition device according to claim 1, wherein the second behavior recognition unit weights each feature value using a weight coefficient determined in advance in accordance with the candidate behavior, and recognizes the candidate behavior based on each feature value weighted.

7. The behavior recognition device according to claim 1, wherein
one or more objects installed in the building are extracted from the room layout information, the one or more objects are classified into any one of a first object that is movable, a second object that is a plumbing facility, and a third object that is a structure of the building, a room feature value in which classification information indicating a classification result is associated with an installation position is extracted for each of the one or more objects, and a behavior selection table is generated based on the room feature value,
the behavior selection table shows one or more spaces of the building that are associated with the corresponding one or more target behaviors, and
the first acquisition unit acquires the behavior selection table as the target behavior information.

8. The behavior recognition device according to claim 7, further comprising:
an installation support unit that is communicably connected to a display terminal, and that is configured to acquire a name of a space of the building in which the image sensor is installed using the display terminal, and output installation guidance to the display terminal, the installation guidance being for installing the image sensor with a field of view including a specific device or a specific facility related to the space.

9. The behavior recognition device according to claim 8, wherein the installation support unit acquires image data captured by the image sensor, detects the specific device or the specific facility included in the image data, and superimposes and displays an annotation image indicating a detection result of the specific device or the specific facility on an image indicated by the image data.

10. The behavior recognition device according to claim 9, wherein the installation support unit acquires a correction instruction of the annotation image using the display terminal to store annotation information indicated by the annotation image corrected in a memory.

11. A method for recognizing a behavior of a user in a building, the method causing a computer to perform the steps of:
acquiring target behavior information including one or more target behaviors that are each to be a predetermined recognition target;
acquiring room layout information on the building; acquiring position information on an image sensor installed in the building;
selecting a candidate behavior that is a recognition candidate from among the one or more target behaviors included in the target behavior information based on the position information on the image sensor and the room layout information;
acquiring image data detected by the image sensor;
determining one or more recognizers corresponding to the candidate behavior with a first behavior recognition unit, and calculating a feature value of the image data using the one or more recognizers;
recognizing the candidate behavior based on the feature value with a second behavior recognition unit; and
outputting a recognition result acquired by the second behavior recognition unit.

12. A non-transitory computer-readable recording medium recording a program for recognizing a behavior of a user in a building, the program causing a computer to function as:
a first acquisition unit that acquires target behavior information including one or more target behaviors that are each to be a predetermined recognition target, room layout information on the building, and position information on an image sensor installed in the building;
a behavior selection unit that selects a candidate behavior that is a recognition candidate from among the one or more target behaviors included in the target behavior information based on the position information on the image sensor and the room layout information;
a second acquisition unit that acquires image data detected by the image sensor;
a first behavior recognition unit that determines one or more recognizers corresponding to the candidate behavior and calculates a feature value of the image data using the one or more recognizers determined;
a second behavior recognition unit that recognizes the candidate behavior based on the feature value; and
an output unit that outputs a recognition result acquired by the second behavior recognition unit.
